(19) United States
(12) Patent Application Publication
(10) Pub. No.: US 2020/0335767 A1
(43) Pub. Date: Oct. 22, 2020

(54) NON-PLANAR ELECTRODES, METHOD OF MAKING SAME, AND USES THEREOF

(71) Applicant: Cornell University, Ithaca, NY (US)

(72) Inventors: Lynden A. Archer, Ithaca, NY (US); Jingxu Zheng, Shenzhen (CN); Qing Zhao, Tianjin (CN)

(21) Appl. No.: 16/853,593

(22) Filed: Apr. 20, 2020

Related U.S. Application Data
(60) Provisional application No. 62/836,486, filed on Apr. 19, 2019.

(51) Int. Cl. H01M 4/04; H01M 4/80; H01M 4/131; H01M 4/1391

(52) U.S. Cl. CPC H01M 4/0423; H01M 4/1391; H01M 4/131; H01M 4/80

(57) ABSTRACT

An electrode or electrode material or catalyst or catalyst material. The material includes an electrically conducting 3-dimensional (3-D) matrix comprising a plurality of porous regions; an active material, and optionally, a carbon conductivity aid, where the active material is disposed in and/or on at least a portion of the porous regions of the electrically conducting 3-D matrix. The electrode or electrode material or catalyst or catalyst material may be made by contacting an electrically conducting 3-D matrix with additive material dispersed thereon with a liquid. An electrochemical device may comprise the electrode or electrode material or catalyst or catalyst material.

### CROSS REFERENCE TO RELATED APPLICATIONS

This application claims priority to U.S. Provisional Application No. 62/836,486, filed on Apr. 19, 2019, the disclosure of which is incorporated herein by reference.

### STATEMENT REGARDING FEDERALLY SPONSORED RESEARCH

This invention was made with government support under grant no. DE-SC0012673 awarded by the Department of Energy. The government has certain rights in the invention.

### BACKGROUND OF THE DISCLOSURE

Rechargeable batteries based on the Li metal anode have reemerged as an area of intense scientific and practical interest in the last decade. The source of this interest is on the one-hand—the specific capacity of the Li anode is one order of magnitude higher than graphite (3860 v.s. 372 mAh/g) and the standard potential for reducing Li ions in solution to the metal (Li⁺+e−=Li(s)) is fully (200-300)mV lower than the corresponding intercalation reaction with graphite to form LiC₆. The interest is on the other hand problematic because the practical energy density of a battery is dependent not only on the anode chemistry, but also on subtle and often ignored parameters, including the negative to positive electrode capacity ratio (N:P ratio), electrolyte to electrodes mass ratio and weight of other battery components, e.g., separator, etc. There are tradeoffs between the often times conflicting design parameter choices that must be made in creating Li metal batteries that live up to the promise offered by the anode. A Li metal cell that uses a conventional intercalating cathode can only truly outperform a conventional Li-ion battery when the N:P ratio is kept below 5:1. Unfortunately, because some fraction of Li in the battery will inevitably be lost to parasitic reactions in forming the solid electrolyte interface (SEI) on the metal anode and because the specific capacity of Li metal is about 20 to 30 times higher than that of conventional intercalation Li-ion cathode (usually around 150 mAh/g), it is extremely difficult to evaluate Li metal anodes under the stringent N:P conditions that will be required to establish practical cell viability.

Of the conventional approaches towards increasing the N:P ratio in a lithium metal battery, strategies which (a) use a thin Li foil (e.g., as created by roll pressing or Physical Vapor Deposition (PVD)) to lower the areal capacity of the anode, 3 or (b) utilize layered cathode architectures to introduce non-planarity and thereby higher areal capacity are the most practiced. Comparing the two approaches, the disadvantages of the former are as plentiful as they are fundamental. First, as the Li foil becomes thinner, more of the active material in the anode is present at the interface with the electrolyte, meaning that a greater fraction of the active anode mass is loss in creating the SEI on Li. Second, the mechanical robustness of anode will deteriorate, meaning that its ability to accommodate cyclic volume changes associated with the large change in specific volume associated with the reversible reaction Li⁺+e⁻=Li(s) during charge and discharge cycles. Third, the weight of the current collector, separator and the electrolyte needed to wet these battery parts will correspondingly increase. Finally, the cost of fabricating thin Li anodes by either approach will add substantially to the overall unit cost. Currently, most conventional cathode structures are based on 2D/planar deposition on a thin metallic current collector, e.g., Al foil. Due to the limited electron transport length scale, the areal loading is rarely higher than 20 mg/cm² which corresponds to an areal capacity of 2-3 mAh/cm². For a 3 mAh/cm² cathode, if the N:P ratio is set to 3:1, the resulting thickness of Li foil is 25 μm, whose commercial availability remains limited. Physical vapor deposition, rather than the conventional casting and rolling procedure, will be necessary to prepare Li foil with this thickness, which makes batteries of this type uncompetitive in terms of cost and ability to be scaled up. For the aforementioned reasons, designing a novel electrode structure that can accommodate a high areal mass loading of active material and can thus offer a high areal capacity comparable with Li foil is a desirable route towards high energy density Li metal batteries.

### SUMMARY OF THE DISCLOSURE

The present disclosure provides electrodes (e.g., cathodes or anodes) or electrode materials (e.g., cathode materials or anode materials), catalysts, and catalysts, and methods for forming electrodes (e.g., cathodes or anodes) or electrode materials (e.g., cathode materials or anode materials), catalysts and catalyst materials. The present disclosure also provides electrochemical devices comprising an electrode (e.g., cathode or anode) or electrode material (e.g., cathode material or and materials) or catalyst or catalyst material, which may be formed using a composition or method of the present disclosure.

In an aspect, the present disclosure provides electrodes (e.g., cathodes or anodes), electrode materials (e.g., cathode materials or anode materials), catalysts, and catalyst materials. Electrodes, electrode materials, catalysts, and catalyst materials can be made by methods of the present disclosure. An electrode (e.g., a cathode or an anode) or electrode material (e.g., a cathode material or an anode material) or catalyst or catalyst material may comprise: an electrically conducting 3-dimensional (3-D) matrix comprising a plurality of porous regions (e.g., voids); an active material, and optionally, a carbon conductivity aid. The active material may be disposed in and/or on (e.g., infiltrated in) at least a portion of the porous regions of the electrically conducting 3-D matrix. An electrodes, electrode material, catalyst, or catalyst material may be a multilayer structure. The electrically conducting 3-D matrix may be surface modified. An active material may be an electrically-conducting active material and/or a catalytically-active active material.

In an aspect, the present disclosure provides methods of forming electrodes (e.g., cathodes or anodes), electrode materials (e.g., cathode materials or anode materials), and catalysts, and catalyst materials. The methods may be used to form an electrode (e.g., cathode or anode), electrode material (e.g., cathode material or anode material), catalyst, or catalyst material of the present disclosure. The electrode or electrode material or catalyst or catalyst material may be made by contacting an electrically conducting 3-D matrix with additive material dispersed thereon with a liquid. The liquid may be a non-aqueous liquid. Force can be applied in various ways. In various examples, the force is applied by a member.

In an aspect, the present disclosure provides devices. The devices comprise one or more electrode (e.g., cathode or anode), electrode material (e.g., cathode material or anode material), catalyst, catalyst material, or a combination of thereof, of the present disclosure and/or one or more electrode (e.g., cathode or anode), electrode material (e.g., cathode material or anode material), catalyst, catalyst material, or a combination of thereof, formed by a method of the present disclosure. A device may be an electrochemical device. Non-limiting examples of electrochemical devices include batteries, supercapacitors, fuel cells, electrolyzers, electrolytic cells, and the like.

### BRIEF DESCRIPTION OF THE FIGURES

For a fuller understanding of the nature and objects of the disclosure, reference should be made to the following detailed description taken in conjunction with the accompanying figures.

FIG. 1 shows the areal capacity of a material of the present disclosure.

FIG. 2 shows rationale for using high areal capacity cathodes in Li metal battery. (a) Energy density of Li-LCO battery; The curves report dependencies of energy density on negative:positive (N:P) capacity ratio and electrolyte: electrodes mass ratio, respectively. (b) Comparison between multilayer thin electrode configuration (left) and single layer thick electrode configuration (right).

FIG. 3 shows design principles and fabrication of nonplanar high areal capacity electrodes. (a) Illustration of the principle that active material particles need to be both electronically and ionically wired. Illustration of the electron transport length scale in (b) 2D/planar electrode and (c) Non-planar electrode based on carbon cloth; (d) illustration of the fabrication of a non-planar cathode. (e) SEM image and (f) EDS mapping of a non-planar LCO cathode.

FIG. 4 shows electrochemical performance of nonplanar high areal capacity electrodes. (a) Charge/discharge profiles of LCO electrodes with different KB carbon contents; (b) discharge voltage profiles of non-planar LCO cathodes with 71, 142 and 213 mg/cm² loading; (c) discharge voltage profiles of 71 mg/cm² LCO cathode at different current density. (d) Discharge profiles of 71 mg/cm² non-planar LCO, LFP and NCM₁₁₁ cathodes. (e) Cycling performance of a Li∥LCO full cells with N:P ratio=4:1. Current density=0.8 mA/cm² in (a), (b) and (d).

FIG. 5 shows Li metal plating/stripping Coulombic efficiency of (a) 1 mAh/cm² and (b) 10 mAh/cm² Li∥Cu cells. In the plating/stripping of Li metal on copper foil, a portion of Li is reacted with electrolyte and causes the formation of SEI; this portion of Li cannot be stripped away. The plating/stripping Coulombic inefficiency is, therefore, a characterization of the amount of reacted lithium.

FIG. 6 shows fabrication of non-planar cathodes and coin cell assembling. The lithium foil anode and the non-planar cathode was separated by a piece of Celgard 3501 polypropylene separator (˜25 μm). A piece of carbon cloth was placed on the separator (a); cathode active material powder was spread on the carbon cloth (b) and a second piece of carbon cloth was placed on the powder (c). 50 μL electrolyte was added into the cathode (d).

The coin cell was closed according to a conventional coin-cell assembling procedure (e). The pressure applied by the coin cell crimper is about 100 bar. In order to examine the non-planar cathode, the coin cell was then opened. The morphology of the non-planar cathode is reported by f, g, and h. (h) demonstrates the flexibility of the non-planar cathode against bending.

FIG. 7 shows SEM morphology of ball milled (a) LCO; (b) LFP; and (c) NCM₁₁₁.

FIG. 8 shows rheological properties of the slurry (90% LCO/10% KB in 1M LiPF₆ EC/DMC). The slurry exhibits a storage modulus that is one order of magnitude higher than its loss modulus, indicating that the concentration of the solids is well above the percolation threshold. The slurry is a yield stress fluid with a yield stress of 9×10² Pa. Therefore, the forces used to drive the slurry should be able to generate a shear stress larger than the yield stress, i.e., 9×10² Pa.

FIG. 9 shows discharge voltage profiles of LCO charged to different voltages.

FIG. 10 shows XANES data of 8 mg/cm²-loading (thin) and 90 mg/cm²-loading (thick) nonplanar LFP cathodes in fully charged state. The equivalent edge position indicates that Fe cations were oxidized to the same oxidation state upon charging to 4.0 V at C/4 rate in both low loading (8 mg/cm²) and high loading (90 mg/cm²) nonplanar LFP electrodes.

FIG. 11 shows SEM images of cycled Li metal in (a) Gen-2 and in (b) 10% FEC/2% VC/Gen-2.

FIG. 12 shows Li plating/stripping using a non-planar electrode. Li plating/stripping Coulombic efficiency and corresponding voltage profile in (a)(b)1M LiPF₆ in EC/DMC, (c)(d) 1M LiPF₆ in 10 w %FEC-EC/DMC and (e)(f) 1 M LiTFSI+0.5% LiNO₃ in DOL/DME. (g) Cycling performance of non-planar Li∥LFP full cells (7 mAh/cm²; N:P≈1:1) in a 1 M LiPF₆ EC/DMC electrolyte containing 10 w % FEC (i.e., Gen-2 electrolyte).

FIG. 13 shows Li deposition morphology in a non-planar electrode. SEM images of Li deposits in (a)(b)1 M LiPF₆ in EC/DMC, (c)(d) 1 M LiPF₆ in 10 w %FEC-EC/DMC and (e)(f) 1 M LiTFSI+0.5% LiNO₃ in DOL/DME. Scale bars: left (a,c,e) 40 μm; right (b,d,f) 10 μm.

FIG. 14 shows Li plating/stripping at planar and non-planar electrodes. XPS spectra of the surface layer formed on Li deposits harvested from: (a) planar and (b) non-planar electrodes in 1 M LiPF6 EC/DMC electrolyte containing 10 w % FEC. (c) Li plating/stripping Coulombic efficiencies on planar current collector at different areal Li throughputs in 1 M LiPF6 EC/DMC. (d) Li plating/stripping Coulombic efficiency and (e) corresponding voltage profile of planar current collector (Li throughput=8 mAh/cm2). XRD analysis of Li electrodeposits harvested after 30 cycles with delithiation to 2 V from (f) planar and (g) non-planar electrodes.

FIG. 15 shows Li plating/stripping in pressure-free O-Ring separated coin cell. (a) Schematic illustration of the O-Ring separated coin cell. (b) Li plating/stripping Coulombic efficiency and (c) corresponding voltage profile measured in the cell. (d) Photo showing orphaned Li detached from the planar Cu substrate filling the internal space of the O-Ring separator.

FIG. 16 shows Li plating/stripping Coulombic efficiency and corresponding voltage profile of 10% FEC EC/DMC, an SEM micrograph of 10% FEC EC/DMC, and an illustration of an electronic pathway via a nonplanar current collector.

FIG. 17 shows a schematic illustration of Li loss caused by dendritic electrodeposition.

FIG. 18 shows measurement of intercalation capacity of carbon cloth. Carbon cloth exhibits an intercalation capacity ˜1.2 mAh/cm² above 0 V v.s. L³⁰ /Li.

FIG. 19 shows SEM of Lithium deposition morphology on planar current collector. SEM images of Li deposits on planar Cu foil in (a)(b) 1 M LiPF6 in EC/DMC, (c)(d) 1 M LiPF6 in 10% FEC-EC/DMC and (e)(f) 1 M LiTFSI+0.5% LiNO3 in DOL/DME. Scale bars: left ones 40 μm; right ones 10 μm.

FIG. 20 shows (a) SEM and (b) EDS mapping of nonplanar LFP electrode.

FIG. 21 shows a schematic illustration of guaranteed electronic pathways via nonplanar current collector.

FIG. 22 shows (a) Li plating/stripping Coulombic efficiency and (b) corresponding voltage profile of planar current collector (Li throughput=0.8 mAh/cm²).

FIG. 23 shows a schematic illustration of random reconnection of orphaned Li.

FIG. 24 shows SEM images of the orphaned Li in O-Ring separated coin cell. Scale bars: left 40 μm; right 10 μm.

FIG. 25 shows a schematic drawing of the visualization experiment setup. The dot on the voltage profile reflects the point that corresponding to the stage of deposition of Na ions in the visualization cell illustration to its right. The arrow represents the direction of Na+ migration.

FIG. 26 shows visualization results reflecting the physical losing of Na during plating-stripping cycles. (a), (b), (c), (d), (e), and (f) Still frames from a video showing how the anode surface was cleaned after a striping cycle. (g) Corresponding voltage profile for the in-situ optical observation of striping and plating. (h) How the size of a single Na dendrite varies with time in a complete charging-discharging cycle. The dendrite described here is not included in (a)-(f). t=0 is set to be the beginning of the charging cycle, not the real time. The left shaded region corresponds to the charging cycle, where the right shaded region corresponds to the discharging cycle. White region corresponds to the resting period. Substrate used for this cell is sodium, and electrolyte used is 1 M NaClO₄ in EC/PC 50:50 volume ratio solution. J=2 mA/cm². (i) Velocity analysis of orphan Na dendrites.

FIG. 27 shows electrochemical and chemical analysis of the Na deposits in both visualization cell and coin cell setup. (a) Corresponding voltage profile for the in-situ optical observation (b)(c) of striping and plating, J=4mA/cm². (b)-(c) Still frames from a video revealing the amount of orphan Na created during cycling. (d) Glass fiber separator used in a Na metal coin cell (the side of Na electrode). (e) XPS data of three samples that represent various form of sodium. (A) curve is the Na dendrite preserved in glass fiber separator, (B) curve is the Na dendrite on Na metal substrate, (C) curve is the pristine Na metal soaked in electrolyte. (f) An illustration of the morphologies of Example 3.

FIG. 28 shows reversibility of Na deposits on various substrates. (a) CE cycling result of various counter electrodes with 1 mAh/cm² Na throughput and a rate of J=0.5 mA/cm². “SS” stands for stainless steel, “CC” stands for carbon cloth, and “Cu” stands for copper. (b) SEM image of a carbon cloth loaded with a 2 mAh/cm² Na throughput and a rate of J=1 mA/cm². Scale bar 10 μm. (d)(e) EDX mappings for sample shown in (b), where (d) is the Na mapping and (e) is the C mapping. Scale bar 10 μm. (c) SEM image of a stripped carbon cloth with a previous Na throughput of 2 mAh/cm² and a discharge rate of J=1 mA/cm². Scale bar 25 μm. (f)(g) EDX mappings for sample shown in (c), where (f) is the Na mapping and (g) is the C mapping. Scale bar 25 μm. Brightness of all EDX maps is normalized.

FIG. 29 shows full cell test results (a) CE cycling and discharge capacity fading results for full cells with sulfur cathodes at the rate of 0.2 C. “pNa” stands for pristine Na metal plate, and “CC” stands for carbon cloth. (b) Capacity-voltage plot for CC/Na anode paired with room-temperature sulfur cathode at rate of 0.2 C.

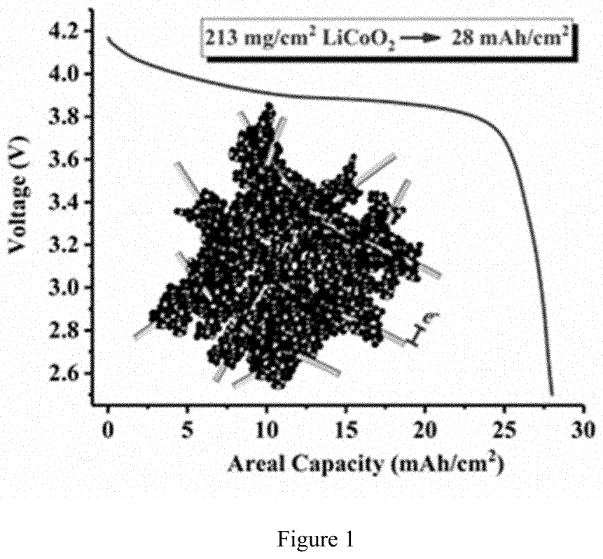

### DETAILED DESCRIPTION OF THE DISCLOSURE

Although subject matter of the present disclosure is described in terms of certain embodiments and examples, other embodiments and examples, including embodiments and examples that do not provide all of the benefits and features set forth herein, are also within the scope of this disclosure. For example, various structural, logical, and process step changes may be made without departing from the scope of the disclosure.

Ranges of values are disclosed herein. The ranges set out a lower limit value and an upper limit value. Unless otherwise stated, the ranges include all values to the magnitude of the smallest value of the stated range (either lower limit value or upper limit value) and all ranges between the values of the stated range.

The present disclosure provides electrodes (e.g., cathodes or anodes) or electrode materials (e.g., cathode materials or anode materials), catalysts, and catalysts, and methods for forming electrodes (e.g., cathodes or anodes) or electrode materials (e.g., cathode materials or anode materials), catalysts and catalyst materials. The present disclosure also provides electrochemical devices comprising an electrode (e.g., cathode or anode) or electrode material (e.g., cathode material or and materials) or catalyst or catalyst material, which may be formed using a composition or method of the present disclosure.

The present disclosure provides non-planar electrode and catalyst architectures, which, in the case of electrodes, enables desirable areal mass loading and capacity. In certain embodiments, the present disclosure relates to the design of a battery electrode/electrode material or catalyst/catalyst material architecture in which ionic and electronic transport pathways are continuous, and span the entire volume of a thick, three-dimensional electrode. In this electrode architecture, active materials (e.g., LiCoO₂, LiFePO₄, etc.) are dispersed into a porous 3-D conductive matrix (e.g., carbon cloth, metal foam, etc.), and an areal capacity of, for example, 28 mAh/cm² is manifested.

The porous, electronically conductive matrixes are, in certain embodiments, able to support a desirable loading of active material particles and, in certain embodiments, infiltration of a liquid electrolyte provides a mechanism for constraining electron and ion transport length scales below the critical values for any arbitrary thickness of the electrode. In some examples, a commercial carbon cloth comprised of interwoven carbon fibers as the electron transport medium. In certain embodiments, a powder-compaction technique in which a composites of nano-sized, commercial battery-grade active materials particles, e.g., LCO, LFP, etc., with a carbon conductivity aid were loaded in the electrolyte-free dry state into the carbon framework. Without intending to be bound by any particular theory, it is considered that once exposed to a liquid electrolyte, capillary forces draw the electrolyte into the interparticle region to enable fast, complete, and desirable (e.g., electrolyte to electrodes mass ratio=0.6:1) wetting of the active material interfaces by a process analogous to wicking.

In an aspect, the present disclosure provides electrodes (e.g., cathodes or anodes), electrode materials (e.g., cathode materials or anode materials), catalysts, and catalyst materials. Electrodes, electrode materials, catalysts, and catalyst materials can be made by methods of the present disclosure. In various examples, an electrode (e.g., cathode or anode), electrode material (e.g., cathode material or anode material), catalyst, or catalyst material is made by a method of the present disclosure. Non-limiting examples of electrodes, electrode materials, catalysts, and catalyst materials are provided herein.

An electrode (e.g., a cathode or an anode) or electrode material (e.g., a cathode material or an anode material) or catalyst or catalyst material may comprise: an electrically conducting 3-dimensional (3-D) matrix comprising a plurality of porous regions (e.g., voids); an active material, and optionally, a carbon conductivity aid. The active material may be disposed in and/or on (e.g., infiltrated in) at least a portion of the porous regions of the electrically conductive matrix.

An electrode, electrode material, catalyst, or catalyst material may be a multilayer structure. A multilayer structure may comprise multiple layers comprising electrical/catalytic materials. In various examples, each individual layer comprises electrical materials and/or catalytic materials. In various examples, a multilayer structure comprises multiple electrical material layers, multiple catalytic material layers, or a combination of electrical material layers and catalytic material layers. In various examples, a multilayer structure comprises two or more electrode material layers(s) or two or more catalytic material layer(s) or one or more electrode material layers (s) and one or more catalytic material layer(s). The layers may be the same or two or more layers may be structurally and/or compositionally different.

An electrode, electrode material, catalyst, or catalyst material may comprise various electrically conducting 3-D matrixes. An electrically conducting 3-D matrix may be referred to as an electronically conductive matrix, porous electronically conductive matrix 3-D electronically conductive matrix, or porous 3-D electronically conductive matrix. An electrically conducting 3-D matrix may be planar or non-planar. An electrically conducting 3-D matrix may be a single layer electrically conducting 3-D matrix or a multiple layer electrically conducting 3-D matrix. In an example, the electrically conducting 3-D matrix is not a ceramic foam.

The electrically conducting 3-D matrix material may have various sizes. In an example, the smallest dimension of the matrix material is 10 microns or greater and/or the porosity of current collector is 20% or greater. The electrically conducting 3-D matrix may have at least one dimension (e.g., a dimension perpendicular to the longest dimension of the electrically conducting 3-D matrix) of at least 10 microns.

An electrically conducting 3-D matrix may comprise (or be) a carbon matrix. A matrix may comprise (or be) a carbon cloth or fabric. In various examples, a carbon cloth or fabric comprises (or is) a single layer of carbon cloth or fabric or multiple layers of a carbon cloth or fabric. A cloth or fabric may be woven or non-woven. A woven cloth or fabric may have a 3-D weave pattern. A non-woven cloth or fabric may be perforated.

An electrically conducting 3-D matrix may comprise a plurality of porous regions (e.g., voids). The porous regions may comprise a plurality of pores (e.g., voids), a portion of which or all of which may be continuous (e.g., in fluid contact). In various examples, the porous regions are continuous such that two or more surfaces (which may two surfaces opposed to each other) of the matrix are in fluid contact. In various examples, the porous regions are continuous throughout the volume of the electrode, electrode material, catalyst, or catalyst material. The porous regions (e.g., voids) may be at least partially, substantially (which may be that a majority of the porous regions/voids are continuous), or completely continuous (which may be that porous regions/voids are in fluid contact). The porous regions (e.g., voids) may, independently or all, have one or more dimension(s) or all dimensions (e.g., one or more linear dimension(s)) of 100 nm to 200 microns, including all integer nm values and ranges therebetween. The porous regions (e.g., voids) may be 30% or more, 50%, 90% or more, or 95% or more of the total volume of the electrically conducting 3-D matrix.

An electrically conducting 3-D matrix may be have various forms. Non-limiting examples of matrixes include carbon frameworks, metal frameworks, and other frameworks formed from other conductive materials, and the like, and combinations thereof. Non-limiting examples of carbon frameworks include carbon fabrics, carbon cloths, graphene aerogels, and the like, and combinations thereof. Non-limiting examples of metal frameworks include metal foams, such as, for example, nickel foams, copper foams, and the like, and combination thereof, and the like, and combinations thereof

The electrically conducting 3-D matrix may be surface modified. At least a portion of or all of the electrically conducting 3-D matrix may be surface modified. In various examples, at least a portion of a surface or all of the surfaces of the electrically conducting 3-D matrix (e.g., a least a portion of a surface of the porous regions/pores and/or at least a portion of an exterior surface of the electrically conducting 3-D matrix) is surface modified. The surface modification may provide desirable electrolyte wettability. The surface modification may provide a hydrophilic and/or metal ion-philic surface. Non-limiting examples of surface modification include surfactant modification, oxidation modification, electrodeposition modification, nano-particle modification, and the like, and combinations thereof.

An electrically conducting 3-D matrix may have desirable electrical conductivity. In various examples, the electrically conducting 3-D matrix has a conductivity of 1 to 10⁸ S/m, including all integer S/m values and ranges therebetween.

An electrode, electrode material, catalyst, or catalyst material may comprise various active materials. An active material may be an electrically-conducting active material and/or a catalytically-active active material. An active material may be a combination of active materials (e.g., two or more structurally and/or compositionally different active materials). The active material may be particulate. An active material may be a nanosized powder. An active material may be a battery-grade powder, such as, for example, a battery-grade nanopowder. Suitable active materials are commercially available. Non-limiting examples of active materials are known in the art.

The active material may be disposed on a portion of or all of a surface or the surfaces of the electrically conducting 3-D matrix and/or in the porous regions/voids. In an example, 70% or more of the active material is in the porous regions (e.g., voids). The active material may not be present only on an exterior surface of the electrically conducting 3-D matrix (e.g., carbon cloth).

An electrode, electrode material, catalyst, or catalyst material may comprise various amounts of active material(s). In various examples, the active material is present at 5 to 90% by weight (based on the total weight of the electrode) and the carbon conductivity aid may be the remainder.

The active material may be an anode material, a cathode material, or a catalyst material. In the case where the electrode or electrode material is a cathode or cathode material, the active material may be one or more ion-conducting material(s), which may be ion-conducting material(s), ion-conducting material(s), lithium ion-conducting material(s), potassium ion-conducting material(s), sodium ion-conducting material(s), magnesium ion-conducting material(s), zinc ion-conducting material(s), aluminum ion-conducting material(s), and the like. Non-limiting examples of lithium-ion conducting materials include LCO, LFP, NCM, LMNO, sulfur, selenium and the like, combinations thereof. Non-limiting examples of potassium-ion conducting materials include cyanoperovskite, and the like, and combinations thereof. Non-limiting examples of sodium-ion conducting materials include Na₃V₂(PO₄)₃, and the like, and combinations thereof. Non-limiting examples of magnesium-ion conducting materials include V₂O₅, and the like, and combinations thereof. Non-limiting examples of zinc-ion conducting materials include MnO₂, and the like, and combinations thereof. Non-limiting examples of aluminum-ion conducting materials include graphite, sulfur, MnO₂, and the like, and combinations thereof, and the like.

In the case where the electrode or electrode material is an anode or anode material, the active material may be a metal or a semi-metal. Non-limiting examples of metals include tin, aluminum, magnesium, lithium, sodium, potassium, zinc, and the like). Non-limiting examples of semi-metals include silicon, MoS₂, and the like.

In the case of catalysts and catalyst materials, the active material may be a catalyst material or catalytic material. A catalyst material or catalytic material may be one or more metal(s), one or more metal alloy(s), one or more metal oxide(s) or a combination thereof. Non-limiting examples of metals and metal oxides include catalytically active metals, catalytically active metal alloys, catalytically active metal oxides, and the like, and combinations thereof. Non-limiting examples of catalytically active metals include late transition metals, such as, for example, noble metals, and combinations thereof. Other non-limiting examples of catalytically active metals include Group 8, Group 9, Group 10, Group 11 metals, and combinations thereof. Non-limiting examples of catalytically active metal oxides include early transition metal oxides and combinations thereof. Other non-limiting examples of catalytically active metal oxides include oxides of Group 4, Group 5, Group 6, Group 7 metals, and combinations thereof. The catalyst material may catalyze reactions, such as, for example, oxygen reduction, carbon dioxide reduction, hydrogen evolution, hydrogen oxidation, and the like.

In the case of catalysts and catalytic materials, the active material may be present in various amounts. In various examples, where the catalyst or catalytic material comprises one or more carbon conductivity aid(s), the ratio of catalyst material to carbon conductivity aid is 5:95 to 95:5 (e.g., 45:55 to 55:45, and 50:50), including all 0.1 catalyst material to carbon conductivity aid ratio values and ranges therebetween.

In cases where the electrically conducting 3-D matrix is a carbon matrix, the active material may be present at 0.01 to 98% by weight, including all 0.01% by weight values and ranges therebetween, (e.g., 0.01 to 20% by weight, 1 to 90% by weight, 1 to 95% by weight, 10 to 95% by weight, or 30 to 98% by weight) based on the total weight of the electrode or electrode material or catalyst or catalyst material (e.g., active material and matrix material and, if present carbon conductivity aid) (e.g., carbon materials, such as, for example, carbon matrix and, if present, carbon conductivity aid).

An electrode, electrode material, catalyst, or catalyst material may comprise various carbon conductivity aid(s). The carbon conductivity aid may be a carbon material or a combination thereof. Non-limiting examples of carbon materials include graphite, Super P, carbon nanotubes, carbon fibers, ketjen black, and the like, and combinations thereof.

The carbon conductivity aid may be a combination of an anisotropic carbon conductivity aid and an isotropic carbon conductivity aid. Non-limiting examples of anisotropic carbon conductivity aids include graphites, carbon fibers, carbon nanotubes, graphenes, and the like). Non-limiting examples of isotropic carbon conductivity aids include ketjen black, Super P, and the like. An isotropic carbon conductivity aid may have a high aspect ratio (e.g., rod-like) structure. Without intending to be bound by any particular theory, it is considered the isotropic carbon conductivity aid may provide increased percolation and/or surface area. Further, the combination of anisotropic carbon conductivity aid and the isotropic carbon conductivity aid may provide a hierarchical structure (e.g., a combination or electrical conductivity and conductive framework).

The anisotropic carbon conductivity aid and isotropic carbon conductivity aid may be present in various amounts. In various examples, the ratio of anisotropic carbon conductivity aid(s) to isotropic carbon conductivity aid(s) is from 40:60 to 60:40 (e.g., 45:55 to 55:45, or 50:50), including 0.1 anisotropic carbon conductivity aid(s) to isotropic carbon conductivity aid(s) ratio values and ranges therebetween.

An electrode, electrode material, catalyst, or catalyst material may comprise various amounts of carbon conductivity aid(s). In various examples, the carbon conductivity aid(s) is/are present at of 1% to 50% by weight, including all integer % by weight values and ranges therebetween, based on the total weight of the electrode or electrode material or catalyst or catalyst material.

An electrode or a catalyst may comprise one or more electrode material(s) and/or one or more catalyst material(s) and/or one or more electrode material layers(s) and/or one or more catalyst material layers(s). In various examples, the electrodes (e.g., cathodes or anodes), electrode materials (e.g., cathode materials or anode materials), are part of rechargeable/secondary batteries, such as, for example, Li-ion batteries, Li metal batteries, sodium-ion batteries, sodium metal batteries, and the like, or primary batteries. The electrodes (e.g., cathodes or anodes), electrode materials (e.g., cathode materials or anode materials), catalysts, and catalyst materials may comprise an active material, which may be a catalytic material and/or an anode material or a cathode material. Suitable examples of active materials are known in the art and non-limiting examples of active materials provided herein. In various examples, an electrode or electrode material does not exhibit metal orphaning. In various examples, an electrode, electrode material, catalyst, or catalyst material does not comprise a binder.

An electrode may comprise one or more electrode material(s) and/or one or more catalyst material(s). The electrode may comprise a current collector other than the electrode material. In an example, an electrode does not comprise a metal current collector. The electrode material may be disposed on a current collector (e.g., a metal current collector). The electrode (e.g., a cathode or an anode) or electrode material may be free of other conducting materials (e.g., carbon-based conducting materials and the like).

In an aspect, the present disclosure provides methods of forming electrodes (e.g., cathodes or anodes), electrode materials (e.g., cathode materials or anode materials), and catalysts, and catalyst materials. The methods may be used to form an electrode (e.g., cathode or anode), electrode material (e.g., cathode material or anode material), catalyst, or catalyst material of the present disclosure. Non-limiting examples of methods are provided herein.

The electrode or electrode material or catalyst or catalyst material may be made by contacting an electrically conducting 3-D matrix with additive material dispersed thereon with a liquid. In various examples, a method of making an electrode or an electrode material or catalyst or catalyst material (e.g., an electrode or an electrode material or catalyst or catalyst material of the present disclosure) comprises: contacting an active material (e.g., an active material powder) and an electrically conducting 3-D matrix; contacting the electrically conducting 3-D matrix and the active material (e.g., the active material powder) with a layer of a material; optionally, contacting the electrically conducting 3-D matrix, the active material (e.g., the active material powder), and the layer of the material with a liquid; and optionally, applying a force to the electrically conducting 3-D matrix, the active material (e.g., the active material powder), the layer of the material, and the liquid, where the and the electrode or electrode material or catalyst or catalyst material is formed. At least a portion of the active material may be infiltrated into the electrically conducting 3-D matrix. The electrically conducting 3-D matrix may be an electrically conducting 3-D matrix described herein. The active material may be a powder, which may be a nanosized powder, of an active material described herein.

The electrically conducting 3-D matrix and the active material powder may be contacted with a layer comprising (or of) various materials. The layer may comprise a sacrificial material and/or be a sacrificial layer. Non-limiting examples layers (or layer materials) include glasses, metals, polymers, plastics, or the like, or a combination thereof The material may be a non-functional material.

A multilayer structure may be formed. A multilayer structure may comprise one or more or two or more electrode material layer(s) and/or one or more or two or more catalytic material layer(s). In various examples, prior to contacting the electrically conducting 3-D matrix, the active material (e.g., the active material powder), and the layer of the material with a liquid and, applying a force, if performed, at least a portion of an exterior surface of the second electrically conducting 3-D matrix may be contacted with a second active material powder and the second layer of a material may be contacted with the second electrically conducting 3-D matrix and a second active material powder. These further contacting steps may be independently repeated a desired number of times to form a multilayer structure.

Various liquids may be used. The liquid may be an electrolyte. The liquid may be an aqueous liquid. In various examples, an aqueous liquid comprises (or is) ZnSO₄, which may be present at, for example, 2 M, in H₂O. The liquid may be a non-aqueous liquid. In various examples, a non-aqueous liquid comprises (or is) LiPF₆, which may be present at, for example, 1 M, in ethylene carbonate.

Force can be applied in various ways. In various examples, the force is applied by a member. The member may have a planar surface. In various examples, force is applied using a press or using any hard solid material, such as, for example, a tweezer, a doctor blade, and the like. It is desirable that the force does not damage the 3-D matrix material(s). In various examples, the force applied does not degrade one or more electrical property(ies) of the 3-D matrix material(s) by more than 10%, more than 5%, more than 1%, or more than 0.1% and/or structurally damage the 3-D matrix material(s).

In an aspect, the present disclosure provides devices. The devices comprise one or more electrode (e.g., cathode or anode), electrode material (e.g., cathode material or anode material), catalyst, catalyst material, or a combination of thereof, of the present disclosure and/or one or more electrode (e.g., cathode or anode), electrode material (e.g., cathode material or anode material), catalyst, catalyst material, or a combination of thereof, formed by a method of the present disclosure. Non-limiting examples of devices are provided herein.

A device may be an electrochemical device. Non-limiting examples of electrochemical devices include batteries, supercapacitors, fuel cells, electrolyzers, electrolytic cells, and the like.

A device can be various batteries. Non-limiting examples of batteries include secondary/rechargeable batteries, primary batteries, and the like. A battery may be an ion conducting battery. Non-limiting examples of ion-conducting batteries include lithium-ion conducting batteries, potassium-ion conducting batteries, sodium-ion conducting batteries, magnesium-ion conducting batteries, aluminum-ion conducting batteries, and the like. A battery may be a metal battery, such as, for example, a lithium-metal battery, a sodium metal battery, magnesium metal battery, or the like. A device may be a solid-state battery or a liquid electrolyte battery.

In the case of a device, which may be a battery, comprising an anode material or anode of the present disclosure, the device may comprise one or more cathode material(s). Examples of suitable cathode materials are known in the art. In various examples, the cathode material(s) is/are one or more lithium-containing cathode material(s), one or more potassium-containing cathode material(s), one or more sodium-containing cathode material(s), one or more magnesium-containing cathode material(s), one or more aluminum-containing cathode material(s), or the like. Examples of suitable cathode materials are known in the art. Non-limiting examples of lithium-containing cathode materials include lithium nickel manganese cobalt oxides, LiCoO₂, LiNi_{1/3}Co_{1/3}Mn_{1/3}O₂, LiNi_{0.5}Co_{0.2}Mn_{0.3}O₂, lithium manganese oxides (LMOs), lithium iron phosphates (LFPs), LiMnPO₄, LiCoPO₄, and Li₂MMn₃O₈, where M is chosen from Fe, Co, and the like, and combinations thereof, and the like, and combinations thereof. Non-limiting examples of sodium-containing cathode materials include Na₂V₂O₅, P2-Na_{2/3}Fe_{1/2}Mn_{1/2}O₂, Na₃V₂(PO₄)₃, NaMn_{1/3}Co_{1/3}Ni_{1/3}PO₄, Na_{2/3}Fe_{1/2}Mn_{1/2}O₂@graphene composites, and the like, and combinations thereof. Non-limiting examples of magnesium-containing cathode materials include magnesium-containing materials (such as, for example, MgMSiO₄ (M=Fe, Mn, Co) materials and MgFePO₄F materials, and the like), FeS₂ materials, MoS₂ materials, TiS₂ materials, and the like. Any of these cathodes/cathode materials may comprise a conducting carbon aid.

In the case of a device, which may be a battery, comprising a cathode material or cathode of the present disclosure, the device may comprise one or more anode material(s). Examples of suitable anode materials are known in the art. Non-limiting examples of anode material(s) include metals, such as, for example, lithium metal, potassium metal, sodium metal, magnesium metal, aluminum metal, and the like, lithium-ion conducting anode materials, sodium-ion conducting anode materials, magnesium-ion conducting anode materials, aluminum-ion conducting anode materials, and the like. Examples of suitable anode materials are known in the art. Non-limiting examples of lithium containing materials include lithium carbide, Li₆C, lithium titanates (LTOs), and the like, and combinations thereof), and combinations thereof. Non-limiting examples of sodium-ion conducting anode material include Na₂C₈H₄O₄ and Na_{0.66}Li_{0.22}Ti_{0.78}O₂, and the like, and combinations thereof. Non-limiting examples of magnesium-containing anode materials include Mg₂Si, and the like, and combinations thereof. The device, which may be a battery, may comprise a material chosen from silicon-containing materials, tin and its alloys, tin/carbon, phosphorus, and the like.

The device, which may be a battery, may comprise a conversion-type electrode (e.g., anode or cathode, depending on which electrode/electrode material of the present disclosure is used). Non-limiting examples of conversion-type electrode materials include air (e.g., oxygen), iodine, sulfur, sulfur composite materials, polysulfides, metal sulfides, such as, for example, MoS₂, FeS₂, TiS₂, and the like, and combinations thereof.

A device, which may be a battery, may further comprise a solid electrolyte or liquid electrolyte. Examples of suitable electrolytes are known in the art.

A device may further comprise a current collector disposed on at least a portion of the cathode and/or the anode. In various examples, the current collector is a conducting metal or metal alloy.

A solid-state electrolyte, cathode, anode, and, optionally, the current collector may form a cell of a battery. The battery may comprises a plurality of the cells and each adjacent pair of the cells is separated by a bipolar plate. The number of cells in the battery is determined by the performance requirements (e.g., voltage output and the like) of the battery and is limited only by fabrication constraints. For example, the battery comprises 1 to 500 cells, including all integer number of cells and ranges therebetween.

The steps of the methods described in the various embodiments and examples disclosed herein are sufficient to produce an electrode or electrode material or catalyst or catalyst material of the present disclosure. Thus, in an embodiment, a method consists essentially of a combination of the steps of the methods disclosed herein. In another embodiment, a method consists of such steps.

The following Statements are examples of electrodes, electrode materials, catalysts, catalyst materials, methods of making electrodes, electrode materials, catalysts, and catalyst materials, and devices of the present disclosure:

Statement 1. An electrode (e.g., a cathode or an anode) or electrode material (e.g., a cathode material or an anode material) or catalyst or catalyst material comprising: an electrically conducting 3-dimensional (3-D) (e.g., planar or non-planar) matrix comprising a plurality of porous regions (e.g., voids); an active material, and optionally, a carbon conductivity aid, where the active material is disposed in and/or on (e.g., infiltrated in) at least a portion of the porous regions of the electrically conducting 3-D matrix. The electrode (e.g., a cathode or an anode) or electrode material may be free of other conducting materials (e.g., carbon-based conducting materials.
Statement 2. An electrode or electrode material or catalyst or catalyst material according to Statement 1, where the porous regions/voids are at least partially, substantially (e.g., a majority of the porous regions/voids are continuous), or completely continuous (e.g., in fluid contact).
Statement 3. An electrode or electrode material or catalyst or catalyst material according to Statement 1 or 2, where the porous regions/voids has one or more or all dimensions of 100 nm to 200 microns, including all integer nm values and ranges therebetween.
Statement 4. An electrode or electrode material or catalyst or catalyst material according to any one of the preceding Statements, where the porous regions/voids are 30% or more, 50% or more, 75% or more, 90% or more, or 95% or more of the total volume of the electrically conducting 3-D matrix.
Statement 5. An electrode or electrode material or catalyst or catalyst material according to any one of the preceding Statements, where the electrically conducting 3-D matrix has a conductivity of 1 to 10⁸ S/m, including all integer S/m values and ranges therebetween.
Statement 6. An electrode or electrode material or catalyst or catalyst material according to any one of the preceding Statements, where the electrically conducting 3-D matrix is a single layer electrically conducting 3-D matrix or a multiple layer electrically conducting 3-D matrix.
Statement 7. An electrode or electrode material or catalyst or catalyst material according to any one of the preceding Statements, where the electrically conducting 3-D matrix is carbon matrix.
Statement 8. An electrode or electrode material or catalyst or catalyst material according to Statement 7, where in the carbon matrix is a carbon cloth/fabric (e.g., a single layer of carbon cloth/fabric or multiple layers of a carbon cloth/fabric).
Statement 9. An electrode or electrode material or catalyst or catalyst material according to Statement 8, where the cloth/fabric is woven or non-woven.
Statement 10. An electrode or electrode material or catalyst or catalyst material according to Statement 9, where the woven cloth/fabric has a 3-D weave pattern.
Statement 11. An electrode or electrode material or catalyst or catalyst material according to Statement 9, where the non-woven cloth/fabric is perforated.
Statement 12. An electrode or electrode material or catalyst or catalyst material according to any one of the preceding Statements, where the electrically conducting 3-D matrix is a carbon matrix and the active material is present at 0.01 to 98% by weight, including all 0.1% by weight values and ranges therebetween, (e.g., 0.01 to 20% by weight, 1 to 90% by weight, 1 to 95% by weight, 10 to 95% by weight, or 30 to 98% by weight) based on the total weight of the electrode or electrode material or catalyst or catalyst material (e.g., active material and matrix material and, if present carbon conductivity aid) (e.g., carbon materials, such as, for example, carbon matrix and, if present, carbon conductivity aid).
Statement 13. An electrode or electrode material or catalyst or catalyst material according to any one of Statements 1-6, where the electrically conducting 3-D matrix is chosen from carbon frameworks (e.g., carbon fabrics, carbon cloths, graphene aerogels, and the like), metal frameworks (e.g., metal foams, such as, for example, nickel foam, a copper foam, and the like, and the like), and other frameworks formed from other conductive materials, and combinations thereof, and the like.
Statement 14. An electrode or electrode material or catalyst or catalyst material according to any one of the preceding Statements, where the active material is disposed on a surface of the electrically conducting 3-D matrix and/or in the porous regions/voids (e.g., 70% or more of the active material is in the porous regions/voids). The active material is not present only on an exterior surface of the electrically conducting 3-D matrix (e.g., carbon cloth).
Statement 15. An electrode or electrode material or catalyst or catalyst material according to any one of the preceding Statements, where the active material is a particulate active material.
Statement 16. An electrode or electrode material or catalyst or catalyst material according to any one of the preceding Statements, where the active material is present at 5 to 90% by weight (based on the total weight of the electrode) and the carbon conductivity aid is the remainder.
Statement 17. An electrode or electrode material or catalyst or catalyst material according to any one of the preceding Statements, where the active material is an anode material, a cathode material, or a catalyst material.
Statement 18. An electrode or electrode or catalyst material or catalyst material according to Statement 17, where the electrode is a cathode and the active material is an ion-conducting material (e.g., one or more lithium-ion conducting material (such as, for example, LCO, LFP, NCM, LMNO, sulfur, selenium and the like, combinations thereof), one or more potassium-ion conducting material (such as, for example, cyanoperovskite, and the like, and combinations thereof), one or more sodium-ion conducting material (such as, for example, Na₃V₂(PO₄)₃, and the like, and combinations thereof), one or more magnesium-ion conducting material (such as, for example, V₂O₅, and the like, and combinations thereof), one or more zinc-ion conducting material (such as, for example, MnO₂, and the like, and combinations thereof), one or more aluminum-ion conducting material, such as, for example, graphite, sulfur, MnO₂, and the like, and combinations thereof), and the like).
Statement 19. An electrode or electrode material or catalyst or catalyst material according to Statement 17, where the electrode is an anode and the active material is a metal (e.g., tin, aluminum, magnesium, lithium, sodium, potassium, zinc, and the like), a semi-metal (e.g., silicon, MoS2, and the like), or the like.
Statement 20. An electrode or electrode material or catalyst or catalyst material according to Statement 17, where the active material is a catalyst material chosen metals and metal oxides. Non-limiting examples of metals and metal oxides include catalytically active metals, catalytically active metal oxides, and the like, and combinations thereof. Non-limiting examples of catalytically active metals include late transition metals, such as, for example, noble metals, and combinations thereof. Other non-limiting examples of catalytically active metals include Group 8, Group 9, Group 10, Group 11 metals, and combinations thereof. Non-limiting examples of catalytically active metal oxides include early transition metal oxides and combinations thereof. Other non-limiting examples of catalytically active metal oxides include oxides of Group 4, Group 5, Group 6, Group 7 metals, and combinations thereof. The catalyst material may catalyze reactions, such as, for example, oxygen reduction, carbon dioxide reduction, hydrogen evolution, hydrogen oxidation, and the like.
Statement 21. An electrode or electrode material or catalyst according to any one of the preceding Statements, where the active material is a catalyst material and the ratio of catalyst material to carbon conductivity aid is 5:95 to 95:5 (e.g., 45:55 to 55:45, and 50:50).
Statement 22. An electrode or electrode material or catalyst or catalyst material according to any one of the preceding Statements, where the carbon conductivity aid is a carbon material (e.g., graphite, Super P, carbon nanotubes, carbon fibers, ketjen black, and the like).
Statement 23. An electrode or electrode material or catalyst or catalyst material according to any one of the preceding Statements, where the carbon conductivity aid is present at of 1% to 50% by weight, including all integer % by weight values and ranges therebetween, based on the total weight of the electrode or electrode material or catalyst or catalyst material.
Statement 24. An electrode or electrode material or catalyst or catalyst material according to any one of the preceding Statements, where the carbon conductivity aid is a combination of an anisotropic carbon conductivity aid (e.g., graphite, carbon fibers, carbon nanotubes, graphene, and the like) and an isotropic carbon conductivity aid (e.g., ketjen black, Super P, and the like). The isotropic carbon conductivity aid may have a rod-like (e.g., high aspect ratio) structure, which may provide increased percolation and/or surface area). The combination of anisotropic carbon conductivity aid and the isotropic carbon conductivity aid may provide a hierarchical structure (e.g., a combination or electrical conductivity and conductive framework).
Statement 25. An electrode or electrode material or catalyst or catalyst material according to Statement 24, where the ratio of anisotropic carbon conductivity aid to isotropic carbon conductivity aid is from 40:60 to 60:40 (e.g., 45:55 to 55:45, or 50:50).
Statement 26. An electrode or electrode material or catalyst or catalyst material according to any one of the preceding Statements, where the electrically conducting 3-D matrix has at least one dimension (e.g., a dimension perpendicular to the longest dimension of the electrically conducting 3-D matrix) of at least 10 microns.
Statement 27. An electrode or electrode material or catalyst or catalyst material according to any one of the preceding Statements, where the electrode material is disposed on a current collector (e.g., a metal current collector).
Statement 28. An electrode or electrode material or catalyst or catalyst material according to any one of the preceding Statements, where at least a portion of a surface of the electrically conducting 3-D matrix (e.g., a least a portion of a surface of the porous regions/pores and/or at least a portion of an exterior surface of the electrically conducting 3-D matrix) is surface modified. The surface modification may provide desirable electrolyte wettability. The surface modification may provide a hydrophilic and/or metal ion-philic surface. Non-limiting examples of surface modification include surfactant modification, oxidation modification, electrodeposition modification, nanoparticle modification, and the like, and combinations thereof.
Statement 29. A method of making an electrode or an electrode material or catalyst or catalyst material (e.g., an electrode or an electrode material or catalyst or catalyst material according to any one of Statements 1-28) comprising: contacting an active material powder an electrically conducting 3-D matrix; contacting the electrically conducting 3-D matrix and the active material (e.g., the active material powder) with a layer of a material (which may be a conducting 3-D matrix or a sacrificial material); optionally, contacting the electrically conducting 3-D matrix, the active material powder, and the layer of the material with a liquid; and optionally, applying a force to the electrically conducting 3-D matrix, the active material powder, the layer of the material, and the liquid (if present), where at least a portion of the active material may be infiltrated into the electrically conducting 3-D matrix and the electrode or electrode material or catalyst or catalyst material is formed.
Statement 30. A method according to Statement 29, where the layer of the material is a second electrically conducting 3-D matrix.
Statement 31. A method according to Statement 29, where, prior to contacting the electrically conducting 3-D matrix, the active material (e.g., the active material powder), and the layer of the material with a liquid and, applying a force, if performed, at least a portion of an exterior surface of the second electrically conducting 3-D matrix is contacted with a second active material (e.g., second active material powder) and a second layer of a material is contacted with the second electrically conducting 3-D matrix and a second active material powder, and, optionally, repeating the contacting steps a desired number of times to form a multilayer structure.
Statement 32. A method according to any one of Statements 29-31, where the active material (e.g., the active material powder) is and active material described herein or a combination thereof (e.g., LCO, LFP, NCM, LMNO, sulfur, selenium, Na₃V₂(PO₄)₃, V₂O₅, MnO₂, and the like).
Statement 33. A method according to any one of Statements 29-32, where the liquid is an aqueous liquid (e.g., 2 M ZnSO₄, at, for example, 2 M, in H₂O or non-aqueous liquid (e.g., LiPF₆, at, for example, 1M, in ethylene carbonate.
Statement 34. A method according to any one of Statements 29-33, where the liquid is an electrolyte.
Statement 35. A method according to any one of Statements 29-34, where the layer of material comprises (e.g., is) glass, metal, polymer, plastic, or the like, or a combination thereof. The material may be a non-functional material.
Statement 36. A method according to any one of Statements 29-35, where force is applied by a member, which may have a planar surface (e.g., using a press or using any hard solid material, such as, for example, a tweezer, a doctor blade, and the like). It is desirable that the force does not damage the 3-D matrix material(s).
Statement 37. A device comprising one or more electrode (e.g., one or more cathode/cathode material and/or anode/anode material) or catalyst according to any one of Statements 1-28 or an electrode (e.g., one or more cathode/cathode material and/or anode/anode material) made by a method according to any one of Statements 29-36.
Statement 38. A device according to Statement 37, where the device is an electrochemical device.
Statement 39. A device according to Statement 38, where the electrochemical device is a battery (e.g., a secondary/rechargeable battery, a primary battery, or the like), a supercapacitor, a fuel cell, an electrolyzer, an electrolytic cell, or the like.
Statement 40. A device according to any one of Statements 37-39, where the battery is an ion-conducting battery.
Statement 41. A device according to Statement 40, where the ion-conducting battery is a lithium-ion conducting battery, a potassium-ion conducting battery, a sodium-ion conducting battery, a magnesium-ion conducting battery, or an aluminum-ion conducting battery.
Statement 42. A device according to any one of Statements 39-41, where the battery further comprises an anode (e.g., a metal anode, such as, for example, a lithium metal anode, a potassium metal anode, a sodium metal anode, a magnesium metal anode, an aluminum metal anode, or the like) and/or one or more electrolyte (e.g., liquid electrolyte, such as, for example, carbonate-based or ether-based electrolyte) and/or one or more current collector and/or one or more additional structural components.
Statement 43. A device according to Statement 42, where the one or more additional structural component is chosen from bipolar plates, external packaging, electrical contacts/leads to connect wires, and combinations thereof.
Statement 44. A device according to any one of Statements 39-43, where the battery comprises a plurality of cells, each cell comprising one or more electrode (e.g., one or more cathode and/or anode) or one or more electrode material (e.g., one or more cathode material and/or anode material), and optionally, one or more anode(s), electrolyte(s), current collector(s), or a combination thereof.
Statement 45. A device according to Statement 44, where the battery comprises 1 to 500 cells.
Statement 46. A device according to any one of Statements 37-45, where battery exhibits one or more of the following: a N:P ratio of at least 1.1 (e.g., 1:1 to 10:1); a mass loading of at least 10 mg/cm² (e.g., 10 mg/cm² to 300 mg/cm²); an areal capacity of 5 to 30 mAh/cm²; a current density of at least 1 mA/cm²; at least 70%, at least 80%, at least 90%, at least 95%, at least 99%, or 100% (e.g., 70 to 100%) of the active material is electrochemically active and/or reversibly electrochemically active; cycle life of at least 100 cycles, at least 500 cycles, at least 1000 cycles, at least 2500 cycles, at least 5000 cycles, at least 7500 cycles, or at least 10,000 cycles; or 60% or greater (e.g., 60 to 90%, 60 to 95%, or 60 to 100%) capacity retention, any one or more of which may be determined under conditions typically used in the art.

The following examples are presented to illustrate the present disclosure. They are not intended to be limiting in any matter.

### EXAMPLE 1

This example provides a description of electrodes and electrode materials, methods of making electrodes, electrode materials, catalysts, and catalyst materials, and devices of the present disclosure.

Described is design of a battery electrode architecture in which ion and electronic transport pathways are continuous, and span the entire volume of a thick, non- planar electrode. It was shown that for a range of active materials conductivities, the length scale for electronic transport in such an architecture can be tuned by simple manipulations of the electrode design to enable good access to the active material. Benefits of such electrodes were demonstrated in low-N:P ratio cells in which a conventional (300-800 μm) Li foil was successfully cycled with LiCoO2 cathodes with high areal capacities (10-28 mAh/cm²).

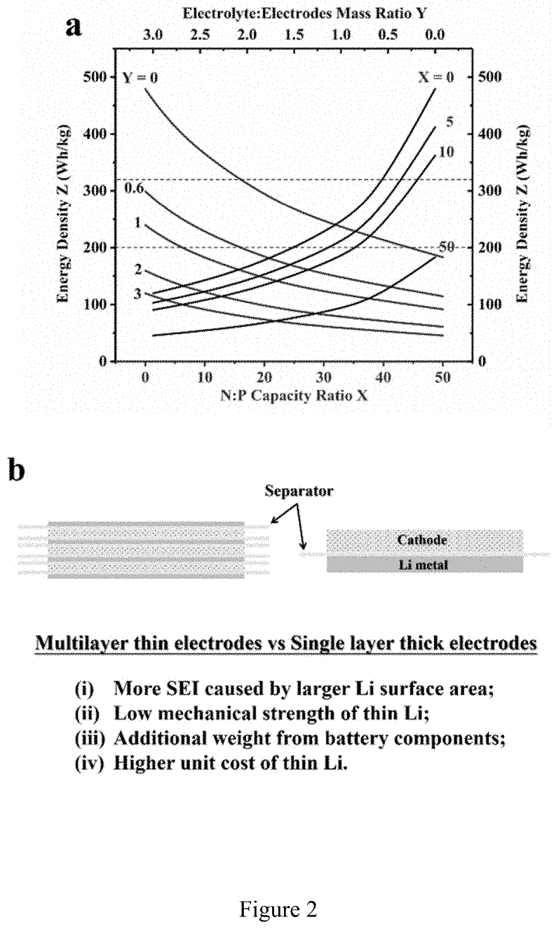

FIG. 2A highlights the tradeoffs between the often times conflicting design parameter choices that must be made in creating Li metal batteries (LMBs) that live up to the promise offered by the anode. The figure shows that a Li metal cell that uses a conventional intercalating cathode can only truly outperform a conventional Li-ion battery when the N:P ratio was kept below 5:1.

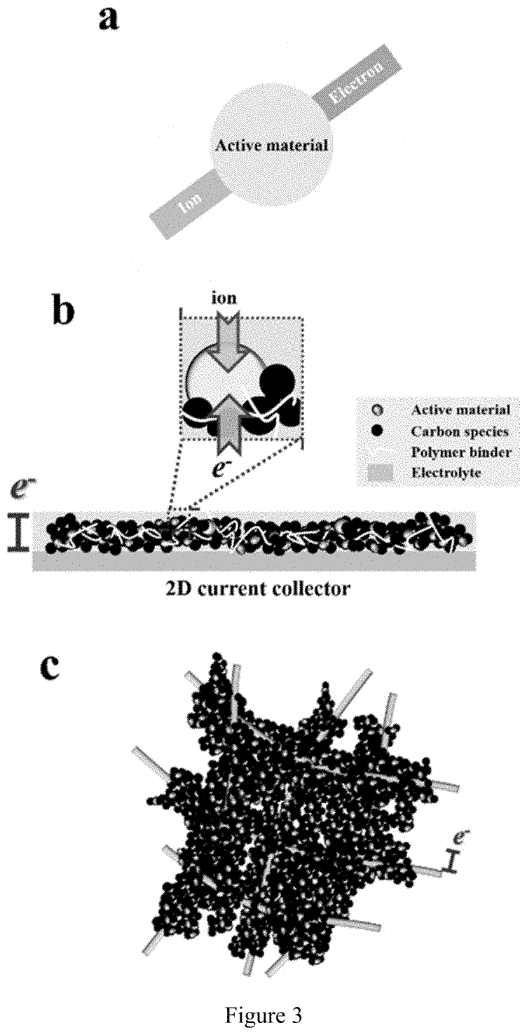

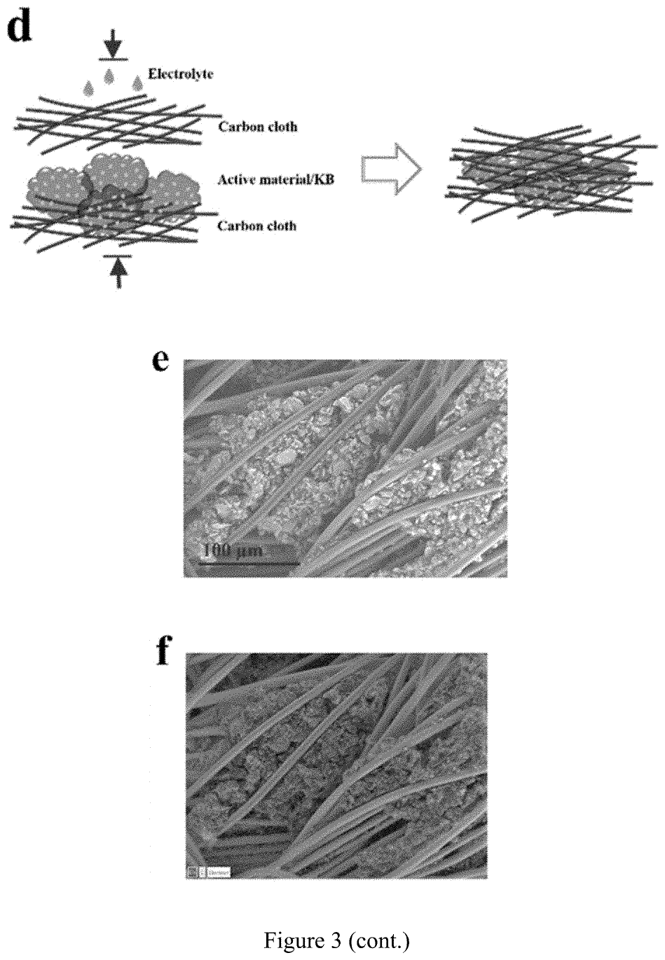

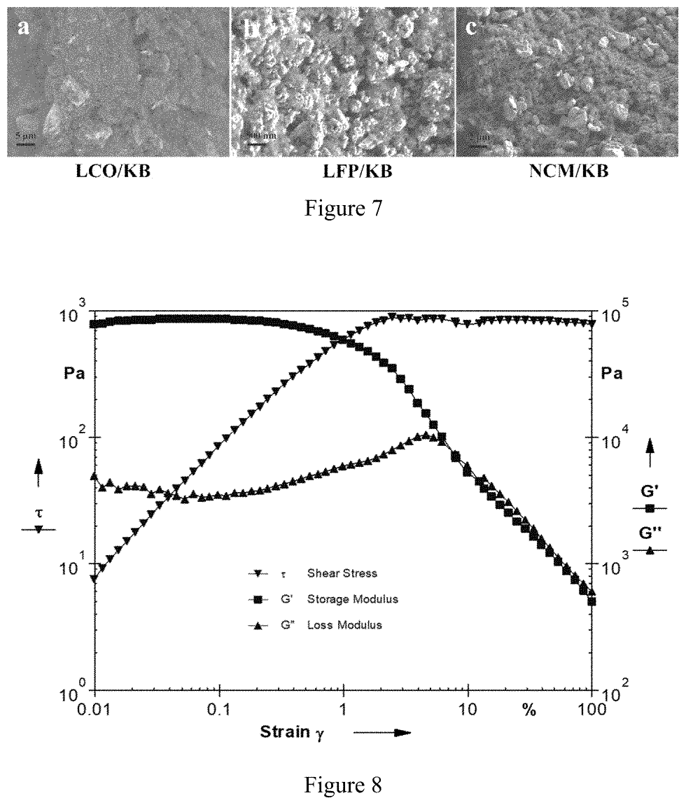

It was hypothesized that a porous, electronically conductive matrix, able to support high loading of active material particles and full infiltration of a liquid electrolyte provides a mechanism for constraining electron and ion transport length scales below the critical values (FIG. 3C) for any arbitrary thickness of the electrode. The use of interwoven carbon fibers as the electron transport medium was evaluated using a commercial carbon cloth comprised of interwoven carbon fibers. Nonplanar carbon matrix is a group of promising current collectors for high areal capacity liquid-based conversion-type cathode, e.g., polysulfides, iodine. For these electrodes, the liquid-based chemistries play an important role in the functioning of the electrodes, in which active material can diffuse and homogenize within the electrode during cycling. While, for intercalation cathode materials that rely on solid reaction, the active material in powder form needs to be homogeneously dispersed into the pores of carbon cloth matrix before battery cycling, which poses difficulties for high areal capacity intercalation-type cathode. To address this issue, a powder-compaction technique was utilized (see FIG. 3D and FIG. 6) in which a composite of nano-sized, commercial battery-grade active materials particles, e.g., LCO, LFP, etc., with a carbon conductivity aid was loaded in the electrolyte-free dry state into the carbon framework. In this strategy, low contact stresses produced by periodically agitating the composite powder were found to be sufficient to break apart any particle aggregates formed in the composite powder (SEM images available are shown in FIG. 7) to enable high fill ratios. Once exposed to a liquid electrolyte, capillary forces draw the electrolyte into the interparticle region to enable fast, complete, and electrolyte to electrodes mass ratio=0.6:1, wetting of the active material interfaces by a process analogous to wicking (rheological properties available in FIG. 8). The electrodes were integrated into coin cells by applying a fixed pressure in the range of 100˜150 bar using a crimper. The mechanical robustness of carbon cloth (tensile strength 345 MPa) due to the interwoven nature maintains the physical integrity of the electrode under the pressure applied. The active material was retained within the matrix by friction force; the electrode architecture was binder-free. FIG. 3E reports the morphology of the fabricated electrode and its corresponding elemental distribution information was probed by EDS mapping (FIG. 3F). A consequence of the large capillary and compression forces exerted on the composite material during electrolyte infusion and cell assembly, respectively, the LCO/KB composite was observed to fill the space between carbon fibers.

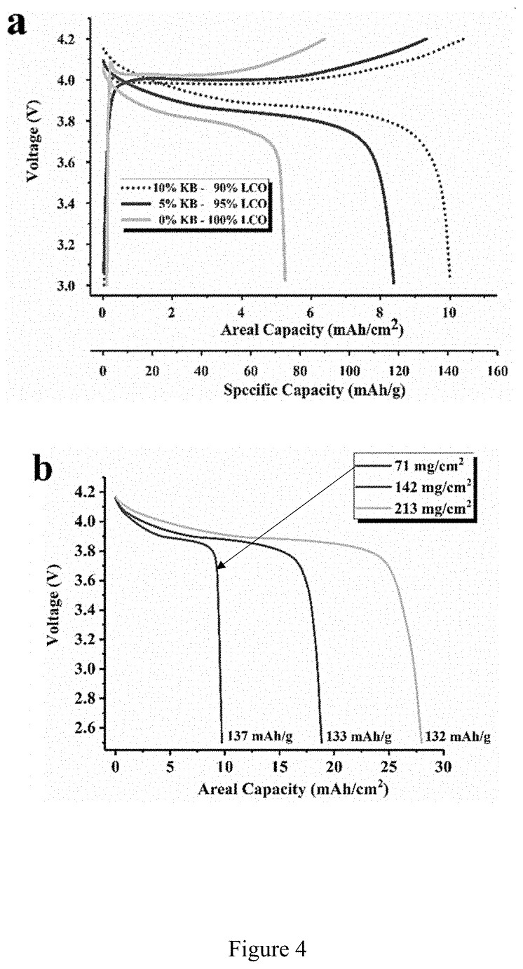

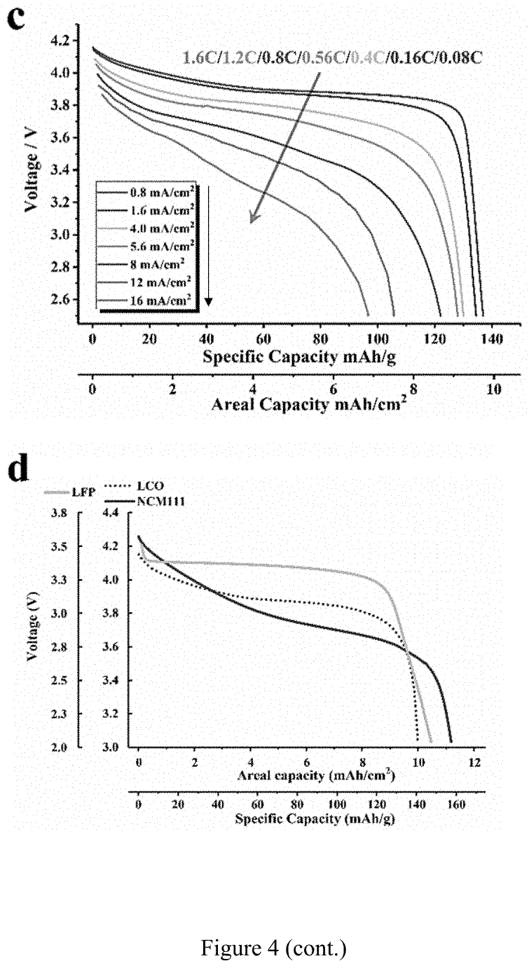

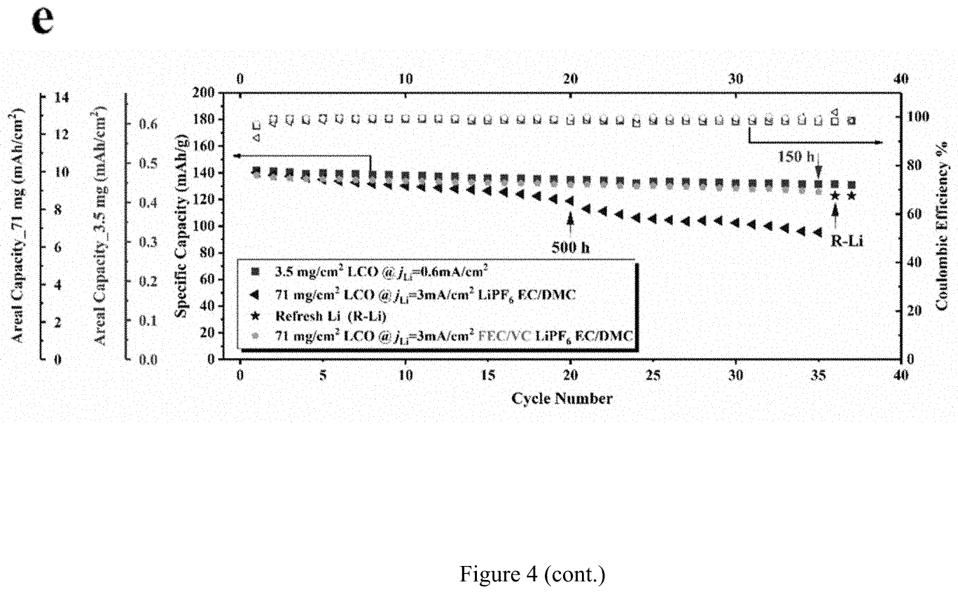

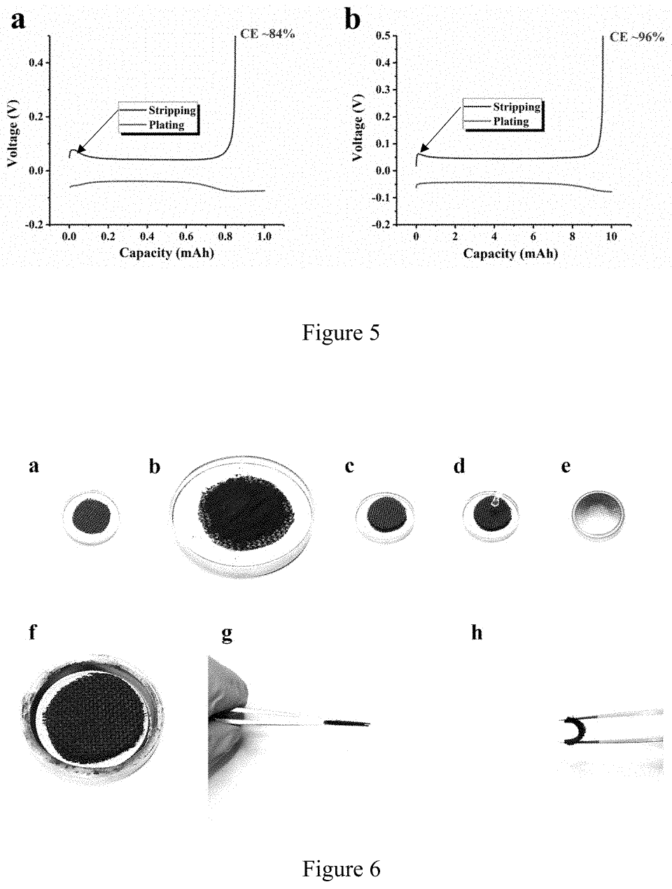

Results from galvanostatic charge-discharge experiments reported in FIG. 4 illustrate the electrochemical characteristics of the electrodes. Specifically, for a high loading of 71 mg/cm² LCO cathode with 10% KB manifested a discharge capacity of 138 mAh/g specific capacity, and a 10 mAh/cm² areal capacity was achieved. The N:P ratios in these batteries are only 4:1, although these experiments use a 750 μm thick Li foil, underscoring the potential benefits of the cathodes for evaluating features of the Li anode under realistic conditions for achieving high cell-level energy densities. When the KB carbon content was decreased from 10 wt % to 5 wt % to 0 wt %, the specific capacity, i.e., the utilization rate of LCO, correspondingly decreases from 138 to 118 to 74 mAh/g, and the voltage hysteresis increases from 0.16 to 0.23 to 0.24 V (FIG. 3A). The results can be understood in a straightforward manner. As the carbon content was lowered, the electron conduction within the KB/LCO composite was weakened and LCO particles insufficiently electronically wired to the system to utilize the full electrode capacity. It was noticeable, however, that the active material utilization rate of LCO was as high as 50% even without any KB black, which was attributed to the intrinsic high electronic conductivity of LCO particles (10⁻¹˜10² S/cm). The results in FIG. 4B show that the strategy can be used to create cathodes with even higher areal mass loading, as high as 213 mg/cm² for a capacity of 28 mAh/cm². These capacities are among the highest reported for a functional LCO cathode. Due to the large pressure applied that removes residue porosity, the volumetric energy density was not significantly compensated by the usage of a nonplanar matrix in the high areal mass loading cathodes (See thicknesses and volumetric energy density in Table 1).

TABLE 1
Parameters of nonplanar LCO cathodes.

| | | | | | Vol. energy |
|---|---|---|---|---|---|
| LCO | Areal | | Thickness¹ | LCO | density³ |
| Loading | capacity | pcs. | (100 bar) | content² | (100 bar) |
| mg/cm² | mAh/cm² | of CC | mm | (wt %) | Wh/cm³ |
| 71 | 10 | 2 | 0.16 | 69 | 2.3 |
| 142 | 19 | 2 | 0.20 | 78 | 3.4 |
| 213 | 28 | 3 | 0.30 | 78 | 3.1 |

¹Thickness of the cathode was measured under ~100 bar pressure by caliper.
²LCO content was calculated on the basis of LCO, KB carbon and carbon cloths.
³Volumetric energy density of cathode was calculated using measured cathode thickness.

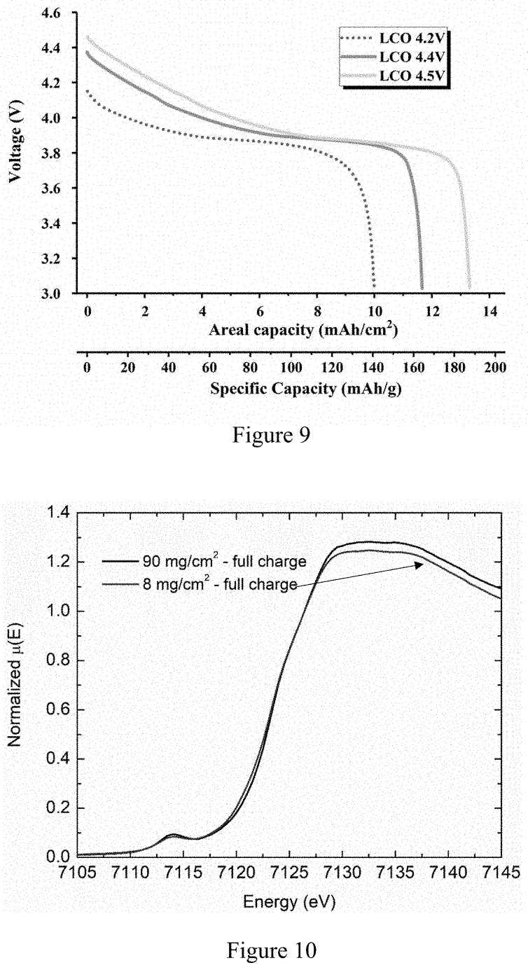

A beneficial attribute of the LCO cathode is that the theoretical specific capacity can be improved by charging to a higher voltage. By charging to 4.5 V specific and areal capacities of 188 mAh/g and a 13.3 mAh/cm², respectively, are achieved (FIG. 9). FIG. 4C reports the effect of current density on the voltage profiles for the 71 mg/cm² LCO cathodes. When discharged at 8 mA/cm², a specific capacity of 122 mAh/g and an areal capacity of 8.7 mAh/cm² are observed, suggesting that the electronic wiring of LCO particles is effective. When the current density was further increased, ion transport within the solid particles can limit the rate performance (characteristic relaxation time

$$τ \approx \frac{{L}^{2}}{{D}_{Li in LCO}} = \frac{{( 10 \times 1 {0}^{- 4} cm )}^{2}}{1 {0}^{- 9} {cm}^{2} {s}^{- 1}} = 1 {0}^{3} s ) .$$

In addition to LCO particles, whose intrinsic electron conductivity is high, the electrode architecture was also compatible with LiNi_{1/3}Co_{1/3}Mn_{1/3}O₂ and, particularly, LiFePO4 that is reported to have a lower electronic conductivity (10⁻⁸ S/cm) (FIG. 4D). Therefore, as illustrated by the electrochemical performances, the electrode architecture described here can serve as a generic platform to upscale cathode mass loading and does not generate heterogeneity due to the increase in mass loading, which was also confirmed by X-ray absorption near edge structure (XANES) study that revealed the oxidation state of the transition metal (See XANES data in FIG. 10). Future efforts towards higher power density cathodes can focus on the optimization of the nonplanar conductive matrix, e.g., its porosity, pore size, thickness, interwoven pattern, etc.

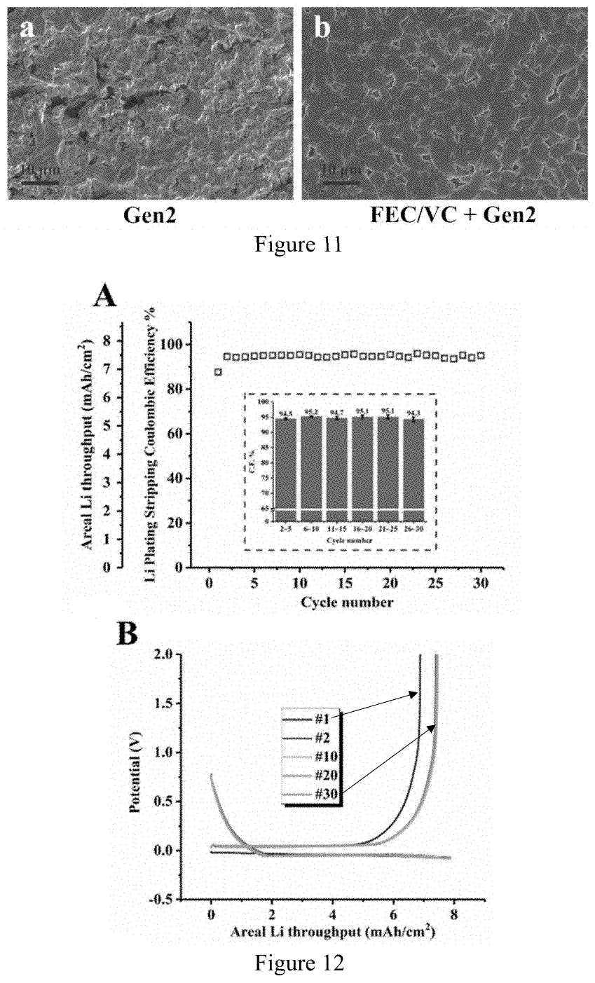

The galvanostatic cycling performance of the Li∥high loading LCO full cells are reported in FIG. 4E. The conditions used for the test provide an extreme test for the Li anode, i.e., at a low N:P capacity ratio=4:1, a high current density j_{Li}=3 mA/cm² and a high lithium throughput=˜30 mAh/cm² per (dis)/charge. To specifically evaluate these effects FIG. 4E compares the cyclability of the bare Li-LCO full cell using a commercial 1M LiPF₆ in EC/DMC as electrolyte with cycling studies in electrolytes containing additives such as FEC that are known to reduce at the Li anode to generate LiF. After 20 deep cycles, which corresponds to approximately 450 hours of continuous cycling and an accumulated Li throughput of ˜1350 mAh/cm², the capacity retention was 84% in the control electrolyte. After 35 deep cycles, the capacity retention was 69%. To understand the origin of the capacity loss, the cycled battery was opened and the Li foil replaced by a fresh anode. Results also reported in FIG. 4E show that this change resulted in restoration of the initial discharge capacity, indicating that the fading was associated with the Li anode. In addition, a low-loading non-planar LCO cathode was paired, which was fabricated via the same procedure, with Li foil, and the capacity retention was 93% after 35 cycles. These results confirm the extreme cycling condition for Li metal leads to the capacity fading. In electrolytes containing 10% FEC/2% VC as additives, 91% of the original capacity was retained after 35 deep cycles, corresponding to 840 hours of cycling at 3 mA/cm². Consistent with previous reports, post-mortem morphology characterization by SEM (FIG. 11) shows that the FEC/VC additive facilitates more compact, less dendritic deposition of Li. This finding underscores the importance of the new cathode architectures as a tool for evaluating electrolyte and separator chemistries for stabilizing Li anodes under practical conditions where the Li throughput per cycle was high.

By designing the electron wiring length scales in electrode, a non-planar electrode architecture that enables battery cathodes with areal capacity as high as 28 mAh/cm² was demonstrated. The cells can be cycled stably against a Li anode over a range of current densities and that because of the high Li throughput (10˜30 mAh/cm²) per (dis)/charge, the cells provide an important tool for evaluating long-term stability of Li metal anodes.

Materials and methods, detailed calculation of energy density, Li metal plating/stripping Coulombic efficiency measurements, details about fabrication of non-planar cathodes and coin cell assembling, SEM morphology of electrode composites, rheological measurements, discharge voltage profiles of LCO charged to different voltages, XANES data, SEM images of cycled Li metal and table summarizing the parameters of nonplanar LCO cathodes.

Materials: Battery grade 1.0 M LiPF₆ in ethylene carbonate/dimethyl carbonate (EC:DMC=50:50 volume ratio; Gen-2 electrolyte) and vinylene carbonate (1,3-Dioxol-2-one, VC) were purchased from Sigma Aldrich. 750 μm lithium foil was purchased from Alfa Aesar. Fluoroethylene carbonate (4-Fluoro-1,3-dioxolan-2-one, FEC) was purchased from AstaTech, Inc. Plain carbon cloth 1071 was purchased from Fuel Cell Store. LiCoO₂ (LCO) powder was purchased from Electrodes and More. LiFePO₄ (LFP) powder and LiNi_{1/3}Co_{1/3}Mn_{1/3}O₂ (NCM₁₁₁) were purchased from MTI. Ketjen Black (KB) carbon was purchased from AkzoNobel.

Characterization of materials and batteries: Field-emission scanning electron microscopy (FESEM) was carried out on Zeiss Gemini 500 Scanning Electron Microscope equipped with Bruker energy dispersive spectroscopy (EDS) detector. Shear rheology measurement was performed using Anton Paar MCR 501. X-ray absorption near edge spectroscopy (XANES) measurements of Li/LFP experimental cells were acquired at beamline 5-ID of the National Synchrotron Light Source II (NSLS II) at Brookhaven National Laboratory. XANES measurements were collected using fluorescence geometry at the Fe edge, and data were aligned and normalized using Athena software.

Electrochemical studies were performed using CR2032 coin cell. The area of carbon cloth is 1.27 cm². The areal density of carbon cloth is 12 mg/cm². The carbon cloth exhibits a tensile strength of 345 MPa (Product Specification). Electrode thickness was measured by MARATHON digital caliper. In N:P=4:1 full cell test, the area of the 750 μm Li foil was 0.32 cm². Separator used in coin cells was Celgard 3501. Galvanostatic charge/discharge performance of coin cells were tested on Neware battery test systems at room temperature. In lithium plating/stripping Coulombic efficiency test (Li∥Cu cell), a certain amount of lithium metal (1 mAh v.s. 10 mAh) was plated on 1.27 cm² copper foil at 0.8 mA/cm² from Gen-2 electrolyte The cutoff voltage for lithium stripping was 0.5 V.

$$Coulombic efficiency = \frac{stripping capacity}{plating capacity} \times 100 \% .$$

Fabrication of non-planar cathodes and coin cell assembling are described in FIG. 6.

Calculation of Li-LCO energy density: To evaluate the minimal requirements of design parameters for a Li metal battery, we calculate the dependency of energy density on these parameters as follows. The energy density of Li-LCO battery with different negative:positive capacity ratios (r_{NP}) and electrolyte:electrodes(r_{EE}) mass ratios are plotted according to:

$$\frac{{C}_{dis} \times {E}_{dis}}{( 1 + {r}_{EE} ) \times ( {r}_{NP} \times {m}_{Li} + {m}_{LCO} / {r}_{act} )}$$

where C_{dis} is discharge capacity; E_{dis} is average discharge voltage; m_{LCO} is the mass of LCO; m_{Li} is the mass of Li that has the same capacity as LCO; r_{act} is the content of active material in cathode.
For example, set W_{LCO}=1 g, which provides a C_{dis}=140 mAh if it is charged to 4.2V.

$${W}_{Li} = \frac{145 m Ah}{3860 m Ah / g} = 0.0 \; 376 g .$$

The average discharge voltage E_{dis} is 3.8V. Hence, the energy density of an anode-free (r_{NP}=0) Li-90% LCO/10% KB (r_{act}=0.9) battery with electrolyte whose mass is 60% of the electrodes (r_{EE}=0.6) charged to 4.2V can be calculated as follows:

$$Energy Density = \frac{140 m Ah \times 3.8 V}{( 1 + 0.6 ) \times ( 0 \times 0.0 \; 376 g + 1 g / 90 \% )} = 299.25 Wh / kg$$

r_{EE}=0 means that the energy density is calculated based merely on the mass of the electrodes. For example, the energy density of an anode-free Li-LCO battery calculated based on electrode mass is:

$$Energy Density = \frac{140 m Ah \times 3.8 V}{( 1 + 0 ) \times ( 0 \times 0.0 \; 376 g + 1 g )} = 478 Wh / kg$$

Of note, currently, the commercial availability of thin lithium (˜30 μm) is limited. Most Li metal studies use lithium foils of conventional thickness, i.e., 250˜750 μm (areal capacity: 50˜150 mAh/cm²); while the cathode areal capacity is rarely above 3 mAh/cm², meaning that the N:P ratio is larger than 17.

In the plating/stripping of Li metal on copper foil, a portion of Li was reacted with electrolyte and causes the formation of SEI; this portion of Li cannot be stripped away. The plating/stripping Coulombic inefficiency is, therefore, a characterization of the amount of reacted lithium.

Cathode material powders (LCO, LFP and NCM111; as received) were ball milled with KB carbon for 20 minutes and were dried in an oven before use. The mass ratio between active material and KB carbon was 90:10, unless specified otherwise (FIG. 4a). No binder was used in electrode fabrication.

The lithium foil anode and the non-planar cathode was separated by a piece of Celgard 3501 polypropylene separator (˜25 μm). A piece of carbon cloth was placed on the separator (FIG. 6a); cathode active material powder was spread on the carbon cloth (FIG. 6b) and a second piece of carbon cloth was placed on the powder (FIG. 6c). 50 μL electrolyte was added into the cathode (FIG. 6d). The coin cell was closed according to a conventional coin-cell assembling procedure (FIG. 6e). The pressure applied by the coin cell crimper was about 100 bar.

In order to examine the non-planar cathode, the coin cell was then opened. The morphology of the non-planar cathode shown in FIGS. 6f˜h. FIG. 6h demonstrates the flexibility of the non-planar cathode against bending.

The slurry exhibited a storage modulus that is one order of magnitude higher than its loss modulus, indicating that the concentration of the solids was well above the percolation threshold. The slurry is a yield stress fluid with a yield stress of 9×10′ Pa. Therefore, the forces used to drive the slurry should be able to generate a shear stress larger than the yield stress, i.e., 9×10² Pa.

### EXAMPLE 2

This example provides a description of electrodes and electrode materials, methods of making electrodes and electrode materials, and devices of the present disclosure.

The dendritic electrodeposition of lithium, leading to physical orphaning and chemical instability, is considered responsible for the poor reversibility and premature failure of electrochemical cells that utilize Li metal anodes. The roles of physical orphaning and chemical instability of electrodeposited Li on electrode reversibility using planar and non-planar electrode architectures were assessed. The non-planar electrodes allowed the morphology of electrodeposited Li to be interrogated in detail and in the absence of complications associated with cell stacking pressure. Physical orphaning is an important determinant of the poor reversibility of Li. Fiber-like, dendritic electrodeposition is an intrinsic characteristic of Li—irrespective of the electrolyte solvent chemistry. With guaranteed electronic access to prevent physical loss, it was shown that a Li metal electrode exhibits desirable levels of reversibility (99.4% CE), even when the metal electrodeposits are in obvious, dendritic morphologies. These findings were used to create high-loading (7 mAh/cm²) Li∥LFP full cells with nearly unity N:P ratio and demonstrate that these cells exhibit good reversibility.

Suppression of mossy/dendritic deposition during recharge is considered a requirement for progress towards practical LMBs. Described is using planar and non-planar electrodes that allow the morphology of Li to be interrogated in detail. With guaranteed electronic access that prevents physical loss of active Li (orphaning, FIG. 17), a Li metal electrode can manifest high levels of reversibility, even when the metal electrodeposits exhibit obvious, dendritic morphologies. It was further shown that electrodes that reduce orphaning are as effective as electrolyte design for achieving high levels of reversibility. As an initial step towards practical LMBs, it was shown that that high-capacity (7 mAh/cm²) Li∥LiFePO₄ (LFP) cells with low anode to cathode capacity ratios (N/P=1:1) can be reversibly cycled in aprotic carbonate liquid electrolytes.

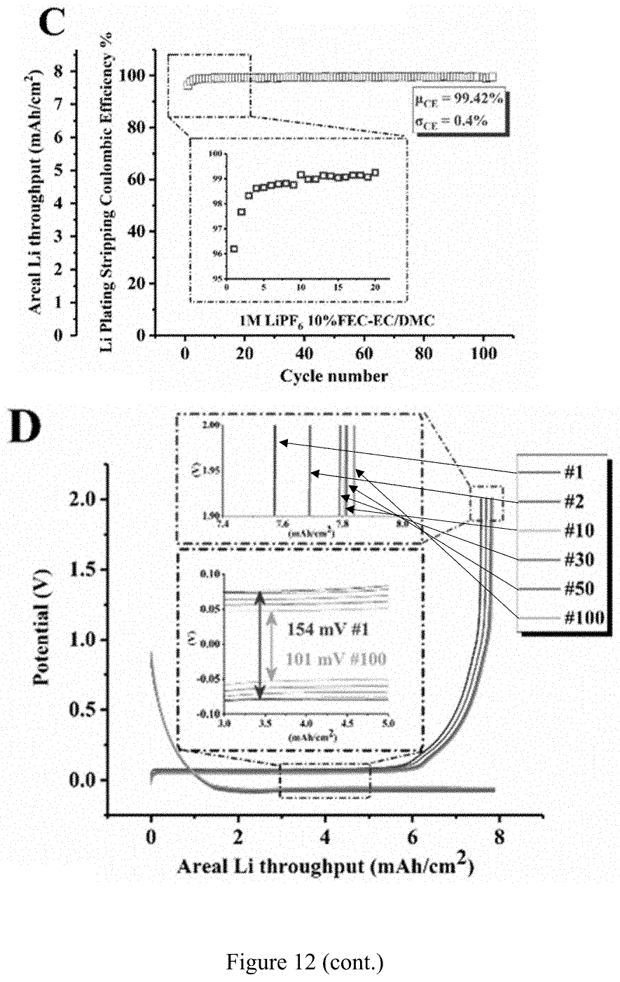

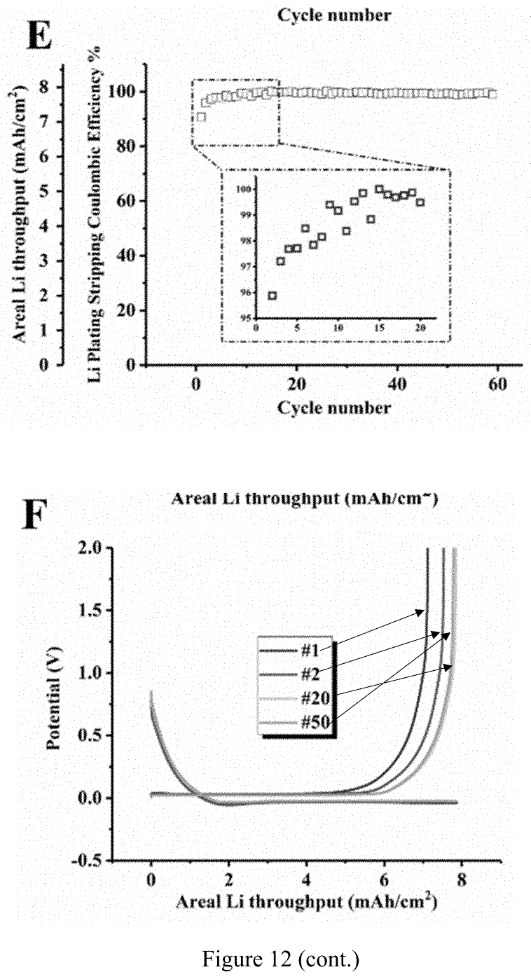

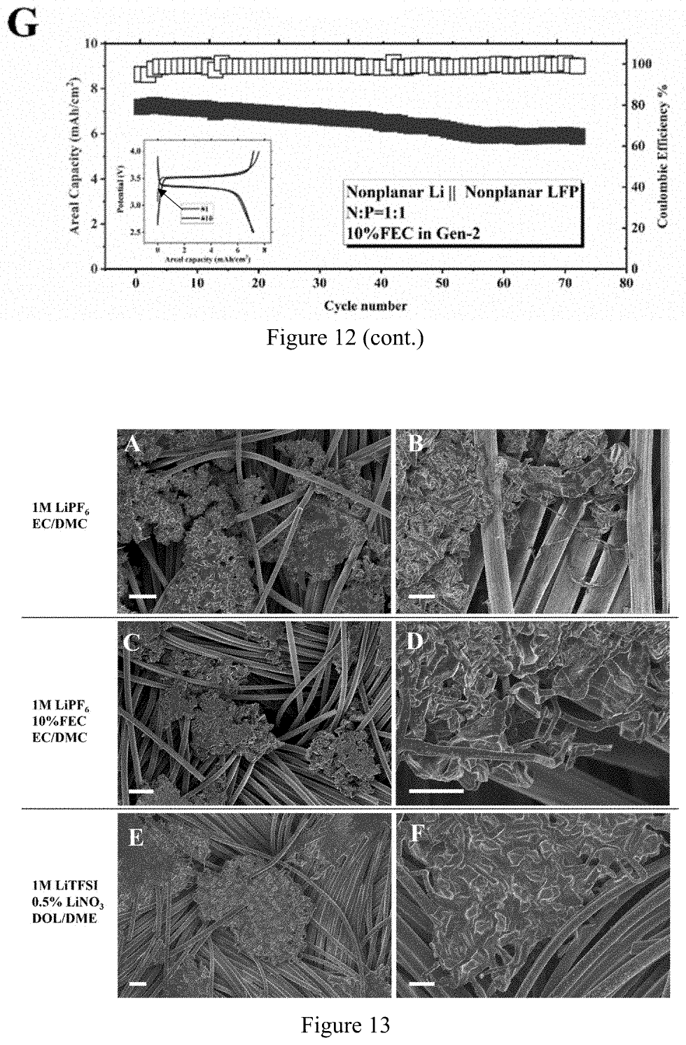

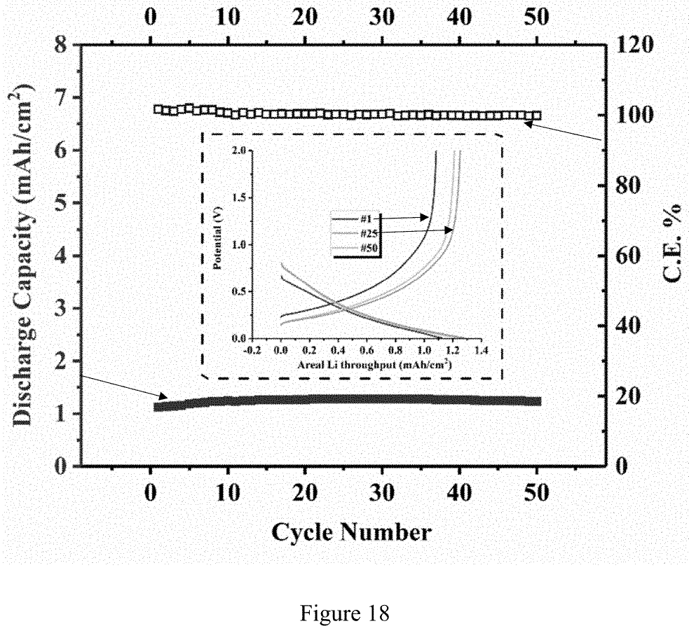

The main results of the study are summarized in FIG. 12 where it is reported that the CE and voltage profiles for Li plating and stripping in various electrolytes. A non-planar carbon-cloth electrode was used for the experiments to facilitate complementary interrogation of the electrodeposit morphology. FIGS. 12A and 12B report results for a standard 1 M LiPF₆ ethylene carbonate/dimethyl carbonate (EC/DMC) electrolyte. The high CE values (94.6% nominal CE and 93.5% real CE after subtracting the intercalation capacity (1.2 mAh/cm², FIG. 18)) and low overpotentials are substantially higher than typical (CE ˜80% at 0.4˜1 mAh/cm²) for this electrolyte chemistry. Without intending to be bound by any particular theory, the low CE for EC/DMC is considered to reflect intrinsic parasitic chemical degradation of the electrolyte and fragility of the interphases formed. As no effect was made to address either failure mechanism, the high CE values reported in FIG. 12 clearly contest this explanation.

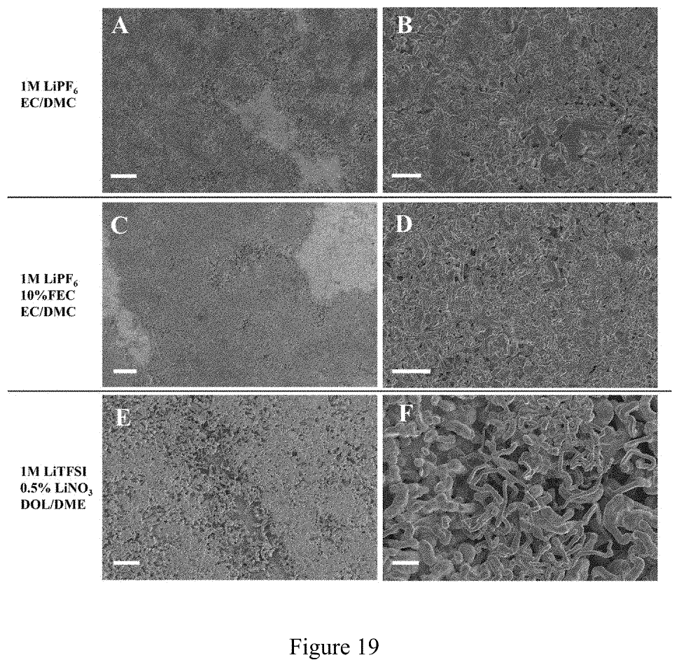

FIGS. 13A and 13B report the corresponding morphology of Li deposits, which can be compared with those in FIG. 19 for Li on a planar Cu foil, with a Celgard 3501 separator. Both sets of results show the deposits are composed of loosely coordinated fibrillar, thread-like structures on the order of 1 μm in diameter. It is noted, however, that for the same Li electrodeposit capacity (8 mAh/cm²), the total exposed surface area of Li is significantly higher in the non-planar electrode than for the planar case. Again, this is opposite to what was observed, which appears to rule-out the chemical instability hypothesis for the low CE reported in the 1 M LiPF₆ EC/DMC electrolyte.

FIGS. 12C and 12D report CE values and voltage profiles for Li stripping/plating experiments conducted in a 1 M LiPF₆ EC/DMC containing 10%FEC. This electrolyte composition is now widely recognized for its ability to enhance Li reversibility. The FEC additive has been reported to breakdown at the Li anode to form a LiF-rich layer, which is thermodynamically stable in contact with Li and hypothesized to protect the electrolyte from continuous parasitic reactions, without compromising interfacial ion transport. The CE values are initially comparable to those measured in the EC/DMC system, but gradually (see inset to FIG. 12C) rise to higher values (nominal CE: 99.4% and real CE: 99.3%). Additionally, even at high Li stripping/plating capacities of 8 mAh/cm², the high CE values are preserved in extended cycling. The corresponding electrodeposit morphologies are reported in FIGS. 13C and 13D; and FIG. 19 for a planar Cu electrode. The results in FIGS. 13A and 13C reveal that the FEC additive has little, if any, effect on the morphology of Li deposits and there was no noticeable change in fiber diameter. Analysis of the corresponding Li morphologies for the planar electrodes (FIG. 19) lead to a similar result. As a final example, Li deposition was investigated in an ether-based, 1 M LiTFSI DOL/DME, electrolyte containing 0.5 wt % LiNO₃. Compared with carbonates, ether-based electrolytes can undergo ring-opening anionic or cationic polymerization at a Li anode to form a protective polymeric coating. The results in FIGS. 12E and 12F show that the initial CE is comparable to the 1 M LiPF₆ EC/DMC, but steadily rises to high values (nominal CE: 99.4% and real CE: 99.3%). Again, the electrodeposit morphologies (FIGS. 13E and 13F) show hardly perceptible differences from those reported in the other two electrolytes. And the morphology of the electrodeposits on the planar electrode (FIG. 19) are more fibrous and dendritic.

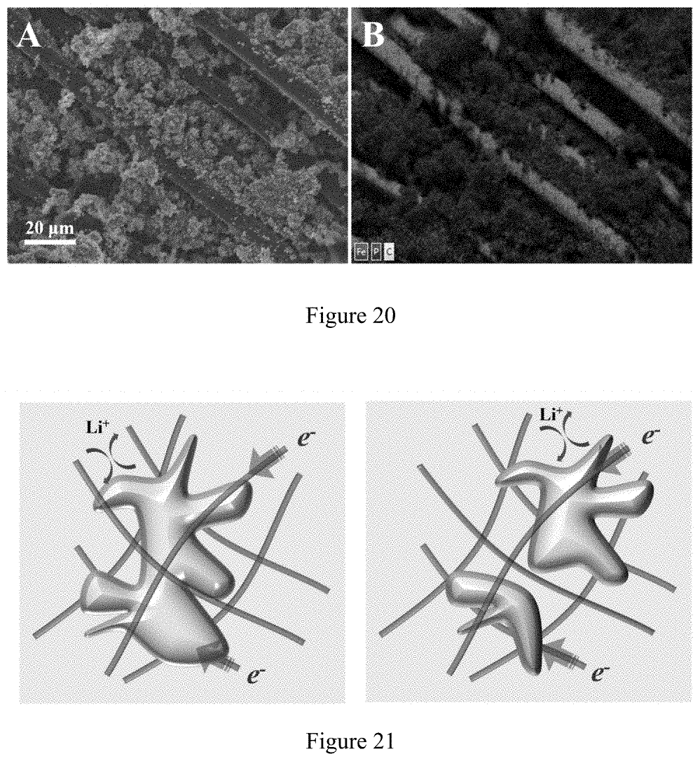

FIG. 12G reports the cycling performance of a high areal capacity Li∥LiFePO₄ full cell (N:P=1:1), in which 7 mAh/cm² Li deposited on carbon cloth serves as the anode. The high-loading cathode used in the study was fabricated using a non-planar architecture reported very recently (See FIG. 20 for details). Even with a stringent N:P=1:1 ratio and a high areal Li throughput, the Li∥LiFePO₄ full cell achieves an 82.5% capacity retention after 70 cycles. If the initial rise in CE apparent in FIGS. 12C and 12G is ignored, the results are consistent with a cell-level average:

$$C {E}_{avg} = exp ( \frac{ln [ \frac{0.825}{2} ]}{70} ) * 100 \% = 9 \; 8.7 \% ,$$

which is close to the measured values. This means that nearly full capacity of both electrodes was achieved in this cycling study. These findings therefore show that a non-planar anode enhances the long-term reversibility of Li metal.

On the basis of these observations, it was concluded that it is possible to sustain stable, high-CE cycling of Li even when the deposition is fiber-like or dendritic. It is further hypothesized that factors other than the electrolyte chemistry or electrodeposit morphology are dominantly responsible for the high CE measured for non-planar electrodes.

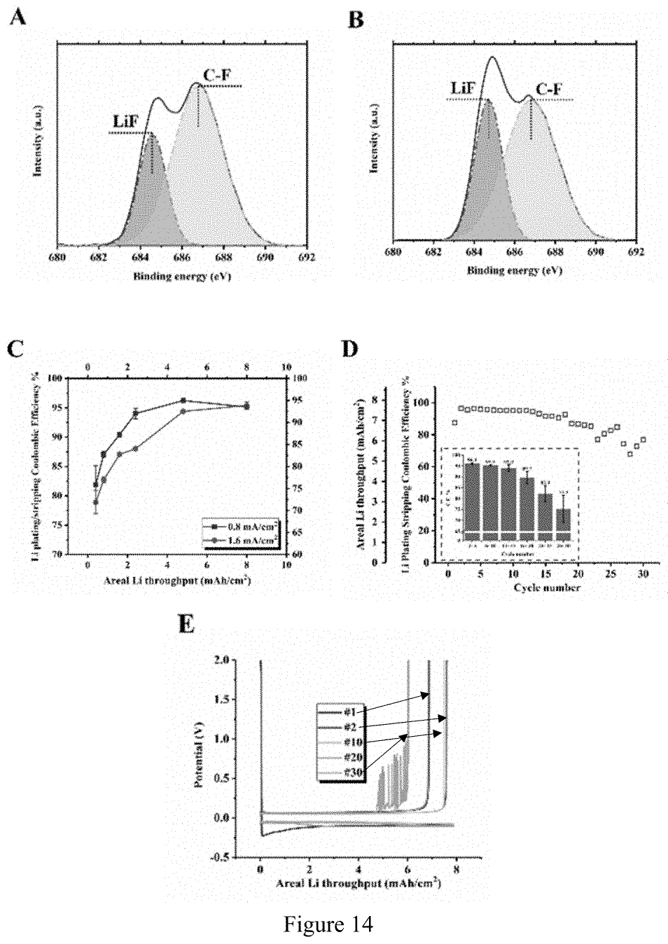

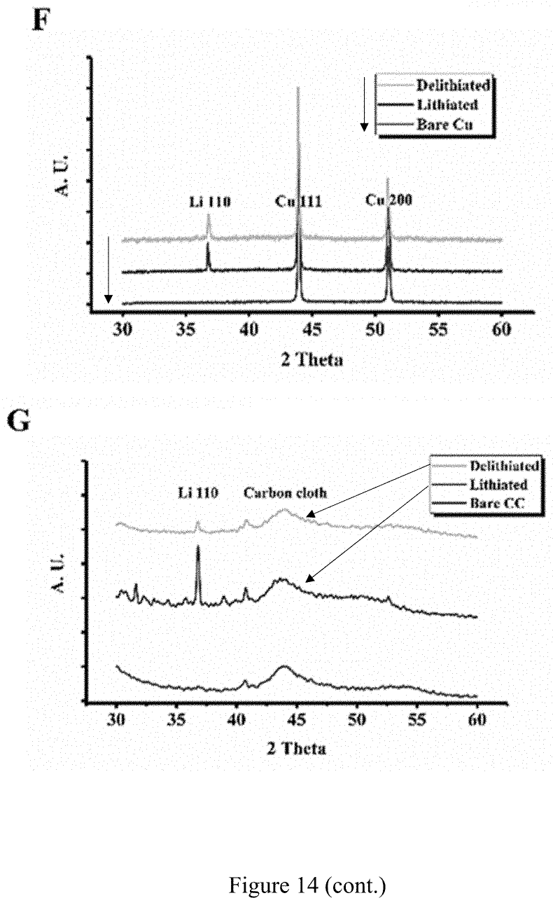

Lithium orphaning occurs when the metal becomes electronically disconnected from the current collector; while the ionic connection is maintained by contact with electrolyte. It has been extensively discussed in the literature as a failure mode for the Li anode, but has received scant consideration as a dominant factor in the poor reversibility of Li. FIG. 21 illustrates how a non-planar electrode might prevent orphaning. These results are consistent with this mechanism and imply that Li orphaning is both a substantial source of Li irreversibility and can be suppressed, if not eliminated, when electronic access is sustained in a non-planar electrode that allows free expansion of the metal. In order to make these observations more concrete, isolatation of the effects of physical loss of Li was attempted by measuring the Li plating/stripping CE on Cu for different Li throughputs. To minimize the effect of chemical instability, the 1 M LiPF₆ EC/DMC-10% FEC electrolyte was chosen. FIGS. 14A and 14B compare the interphases formed on Li in the planar Cu and non-planar electrode. It was seen that fluorinated species, including LiF, dominate the interphasial chemistry. The higher LiF fraction observed for the non-planar electrode is also consistent with the SEM observations in FIG. 13 and FIG. 19, which show that the surface area of Li exposed to the electrolyte is higher for the non-planar case. FIG. 14C reports the CE at different areal Li throughputs. Notably, the CE increases from 81.9% at 0.4 mAh/cm² to 96.2% at 4.8 mAh/cm² and 95.1% at 8.0 mAh/cm² (current density=0.8 mA/cm²), showing a strong initial dependence on throughput followed by a plateauing behavior. The initial rise in CE has not been reported but can be understood in a straightforward manner: chemical instability of Li is positively correlated to the exposed surface area. If Li forms a self-limiting, electrochemically inert SEI, the exposed surface area should be ideally invariant with increased Li throughput. In other words, if a fixed amount of Li is consumed to form the SEI, the fraction of irreversible Li capacity associated with SEI formation should decrease approximately linearly with the Li throughput. This behavior is consistent with the initial rise observed but is not consistent with the plateau at higher Li throughputs.

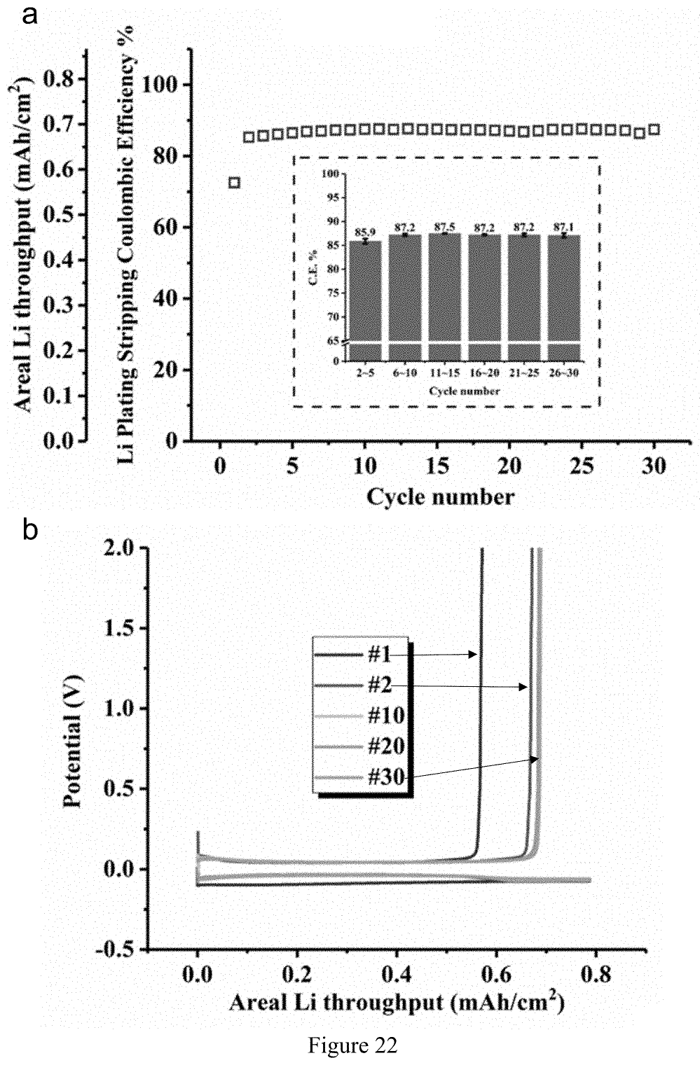

The plateau implies that there is an interplay of multiple factors—e.g., the reduced chemical instability is offset by increasingly prominent Li orphaning at the higher Li throughputs. This explanation is supported by results reported in FIGS. 14D & 14E where it was observed that after 10 high-CE plating/stripping cycles at 8 mAh/cm², the CE measured in Li∥Cu cells becomes increasingly erratic (see magnitude of the error bars in the inset of FIG. 14D), and on average lower as cycling progresses. These behaviors are accompanied by strong and obvious fluctuations in the discharge voltage (FIG. 14E), particularly in the Li stripping segment of the cycle. They are quite different from what was observed at a lower Li throughput of 0.8 mAh/cm² (see FIG. 22) where neither the erratic CE nor the voltage fluctuations are observed in extended Li plate/strip cycling in the same electrolyte. They are also completely absent in cells that utilize a non-planar electrode (FIGS. 12A-F), even at comparably high nominal Li throughputs (8 mAh/cm²).

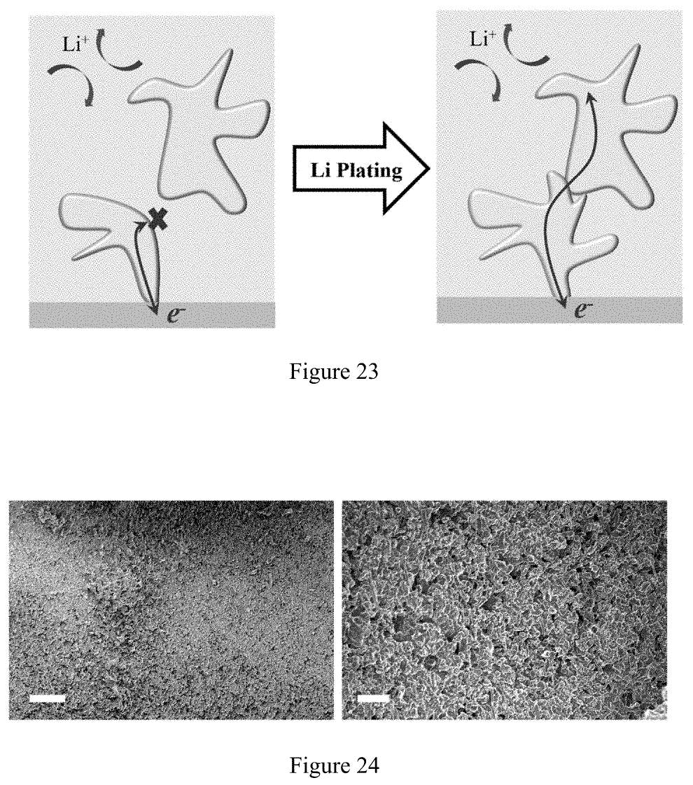

The erratic CE and voltage fluctuations is ascribed to the possibility that orphaned Li in one plating/stripping cycle can be reconnected when Li is deposited appropriately 6 cycles. This random breakage and rebuilding of electronic access to Li (see scheme in FIG. 23) would lead to the observed scattering of the CE. Similarly, in the stripping cycle, orphaned Li can be reconnected due to morphological change, causing the potential spikes—the potential drops back to near 0 V v.s. Li+/Li when a piece of orphaned lithium was reconnected. Results reported in FIG. 14F confirm that orphaned Li was indeed responsible for the observed behaviors. Specifically, the figure reports x-ray diffraction (XRD) data for Li plated and stripped from Cu foil after 30 Li plating/stripping cycles (delithiated to 2V v.s. Li⁺/Li). It was apparent from the figure that a strong Li 110 peak at 35.9° 2θ was observed on Cu even after the delithiation step, indicating that a large amount of electrochemically inactive Li remains stranded at the electrode. It is significant that none of these behaviors are present in any of the electrolytes studied when a non-planar electrode was used. FIG. 14G for instance shows that delithiation of Li leads to a nearly complete disappearance of the Li 110 XRD peak. The non-planar electrode appears to prevent orphaning by maintaining continuous electrochemical access to the Li electrodeposit.

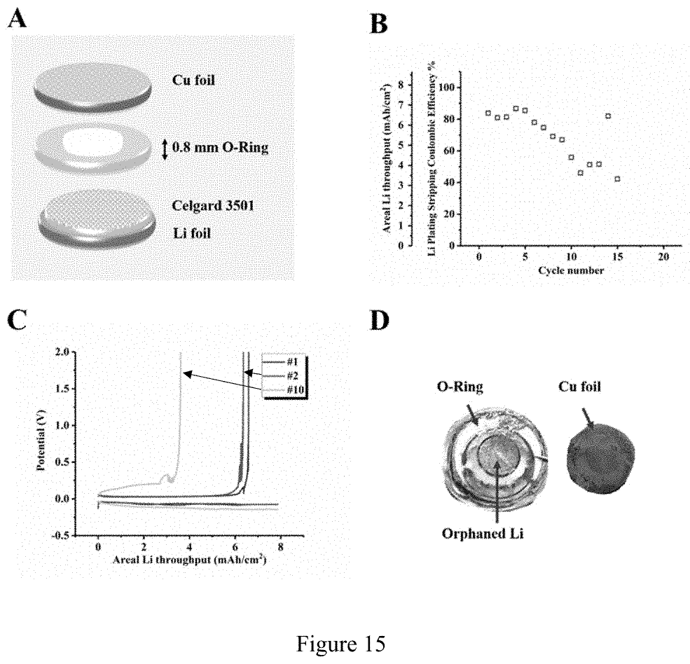

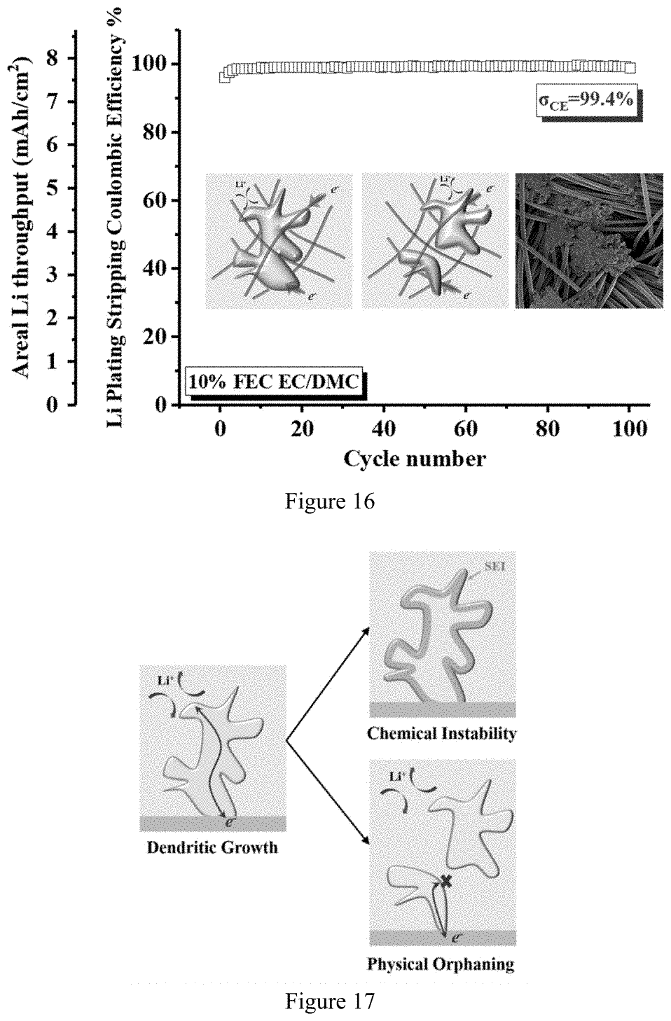

As a final step, the separator from the planar Li∥Cu cells was removed and the CE and morphology of Li electrodeposits were evaluated. An O-Ring separated coin cell was designed (FIG. 15A) in which the backpressure produced by a conventional separator was removed. To avoid interference from dendrite-induced short circuits, a Celgard separator was placed between the O-Ring and the Li foil. FIG. 15B shows that the CE and reversibility are generally low (˜80% for the initial 5 cycles, and <50% thereafter). FIG. 15C reveals noticeable voltage spikes and fluctuations from the very first cycle. The coin cells were opened after 15 cycles (delithiated to 2 V v.s. Li⁺/Li), and even from visual inspection it can be seen that the originally empty space in the O-Ring was filled with orphaned Li (FIG. 4D). SEM characterization (FIG. 24) shows that Li that remains in contact with Cu was essentially identical to that achieved in Li∥Cu cells that use a separator or those that use a non-planar electrode. These findings indicate that physical loss of Li due to orphaning plays a rather large role in the poor reversibility of the Li metal anode. These findings call attention to the need for more advanced non-planar anode architectures with nanoscale structure that are, for example, better matched to the length scales of Li electrodeposit fiber dimensions than the simple carbon-cloth material used in the present disclosure.

By interrogating the electrochemical properties and morphology of Li electrodeposits formed in a non-planar, carbon-cloth electrode in various liquid electrolytes, it was found that relative to the more commonly studied chemical and morphological instabilities, physical orphaning of Li is the key cause of poor reversibility of Li metal anodes. With successful prevention of physical orphaning by building robust non-planar electronic pathways in the anode, it was further shown that Li anodes with high levels of reversibility can be created even when the metal electrodeposits in obviously dendritic morphologies.

Materials and methods: Materials: Battery grade 1.0 M LiPF₆ in ethylene carbonate/dimethyl carbonate (EC:DMC=50:50 volume ratio; Gen-2 electrolyte) and lithium bis(trifluoromethanesulfonyl)imide (LiTFSI) were purchased from Sigma Aldrich. 750 μm lithium foil was purchased from Alfa Aesar. Fluoroethylene carbonate (4-Fluoro-1,3-dioxolan-2-one, FEC) was purchased from AstaTech, Inc. 1,2-dimethoxyethane (DME) and 1,3-dioxolane (DOL) were purchased from Oakwood Chemical. Plain carbon cloth 1071 was purchased from Fuel Cell Store. LiFePO₄ (LFP) powder was purchased from MTI. Ketjen Black (KB) carbon was purchased from AkzoNobel.

Characterization of materials: Field-emission scanning electron microscopy (FESEM) was carried out on Zeiss Gemini 500 Scanning Electron Microscope equipped with Bruker energy dispersive spectroscopy (EDS) detector. X-ray photon spectroscopy (XPS) SSX-100 was applied to study the chemistry information of SEI of Li deposits on nonplanar carbon cloth and on planar Cu foil. The x-ray diffraction (XRD) pattern of Li anodes were performed on a Bruker D8 Powder Diffractometer.

Electrochemical measurements: Galvanostatic charge/discharge performance of coin cells were tested on Neware battery test systems at room temperature. Electrochemical studies were performed using CR2032 coin cells. The area of electrodes in this study is 1.27 cm². Electrodes are separated by Celgard 3501. Cu foil and carbon cloth were washed by ultrasonication in deionized water and acetone. In each coil cell, ˜60 μL electrolyte was added by pipette. The current density in this study was kept at 0.8 mA/cm². The thickness of the Teflon O-ring was ˜0.8 mm. For the O-Ring measurements, ˜200 μL electrolyte was added into the cells to make sure the space was filled. In a lithium plating/stripping Coulombic efficiency measurement (Li∥Cu cell or Li∥carbon cloth cell), a certain amount of lithium metal was plated on the substrate of interest.

$$Nominal Coulombic efficiency = \frac{stripping capacity}{plating capacity} \times 100 \% . \\ Real Coulombic efficiency = ( 1 - \frac{plating capacity - stripping capacity}{plating capacity - intercalation capcity} ) \times 100 \% .$$

The detailed fabrication procedures of high loading nonplanar LFP cathode (˜7 mAh/cm²) are described in our recent publication. The concept in designing this ultrahigh loading LFP electrode is that with nonplanar electronic pathways that expand throughout the cathode chamber, particulate active materials can be electronically and ionically wired to the electrochemical system. Electrolyte served as a fluid that drives particulate active materials into a nonplanar porous medium. 90 wt % LFP and 10 wt % KB were ball milled for 40 minutes before being infiltrated into carbon cloth. No polymer binder, e.g., PVdF, was added.

### EXAMPLE 3

This example provides a description of electrodes and electrode materials, methods of making electrodes and electrode materials, and devices of the present disclosure.

This example describes creating Na metal anodes that can be reversibly cycled at room temperature. Specifically, by studying the plating and stripping reactions at a Na metal anode using in-situ optical visualization, it was found that orphaning of Na metal is a source of irreversibility in liquid electrolytes. It was further shown that orphaning is triggered by a root-breakage process during the stripping cycle, which is exacerbated by the fragility of mossy Na electrodeposits formed spontaneously during electrodeposition. As an initial step towards electrode designs that are able to accommodate these fragile deposits, electrodeposition of Na was studied in non-planar electrode architectures that provide continuous and morphology agnostic access to the metal at all stages of electrochemical cycling. On this basis, it was found non-planar Na electrodes that exhibit high levels of reversibility (Coulombic Efficiency>99% for 1 mAh/cm² Na throughput) in room-temperature, liquid electrolytes.

Direct, in-situ optical visualization and complementary surface analysis studies of electrochemical processes at a Na anode to elucidate failure mechanisms of the anode were performed. It was found that while morphological and chemical instability of Na lead to decidedly low-efficiency and non-planar/mossy deposition of the metal during battery recharge, orphaning (physical loss of Na) during anode discharge is an important determinant of anode reversibility. Specifically, it was found that the low Coulombic Efficiency (CE) of

Na electrodes is principally a result of mechanical breakage and consequent electronic disconnection of large fragments of low-density, mossy Na electrodeposits from the electrode mass. It was further found that by constraining the deposition in a generic structured electrode architecture composed of interwoven carbon fibers (i.e. a carbon cloth) and a limited pore spacings (about 10 μm for the carbon cloth used in this study) comparable to the diameter of the mossy deposits (about 400 μm in the case of free growth, and 50 μm in the case with constraints by the anode framework), it is possible to completely arrest orphaning of Na without application of mechanical pressure to the electrode. High CE values, exceeding 99% in many cases, can be achieved in plate-strip cycling of a Na anode in liquid electrolytes, confirming that orphaning of Na plays a dominant role in its notoriously poor reversibility. Finally, it was shown that rechargeable batteries that pair a highly reversible Na anode with a sulfur/carbon composite (MOFS) cathode exhibit desirable overall reversibility and cycling.

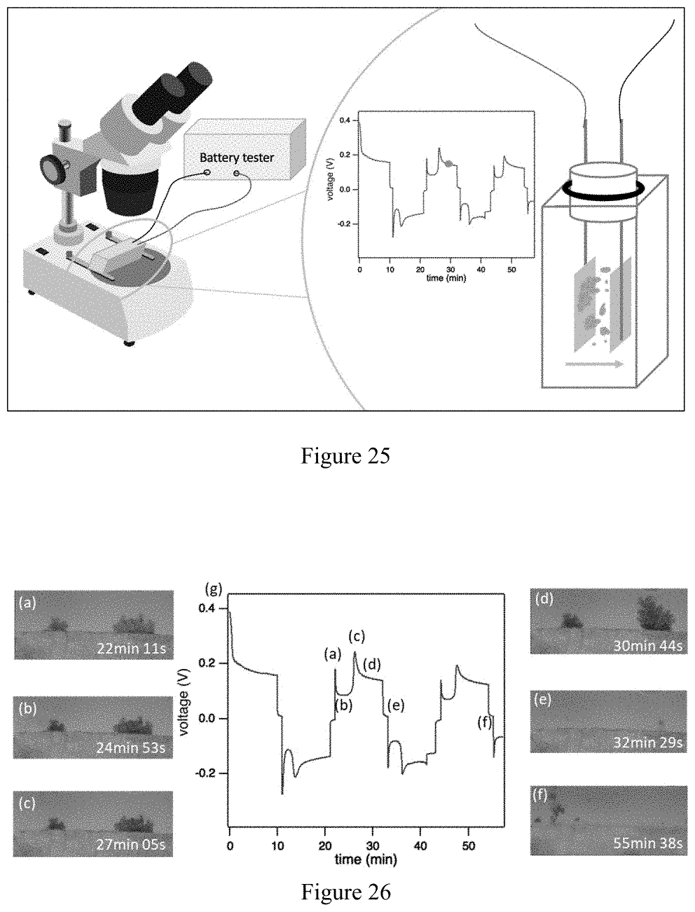

Result and Discussion: Optical Visualization of Na Deposition: The apparatus shown in FIG. 25 was used to track the time-dependent nucleation and growth of Na electrodeposits on a substrate. This apparatus design is compatible to use many thin substrates such as copper (Cu) foil and stainless steel (SS) plate, but here, all the visualization results reported were collected from a Na—Na symmetric cell setup. The apparatus consists of a custom-designed optical two-electrode electrochemical cell that is small enough to fit in the sample compartment of an optical microscope outfitted with long working distance objectives. The experiments reported in this Example used an electrolyte composed of 1 M NaClO₄ and a carbonate solvent mixture that was prepared by mixing equal volume of ethylene carbonate (EC) and propylene carbonate (PC). Measurements were performed in a configuration where the light path and imposed electric field are approximately orthogonal. The cell was interfaced with a potentiostat, which allowed simultaneous application of a fixed current and measurement of the overall voltage response as Na was stripped from one electrode and plated onto the next. By performing measurements in which the electrode polarity is periodically switched, it was possible to directly visualize changes in Na electrodeposit morphology over multiple cycles of plating and stripping from a planar electrode.

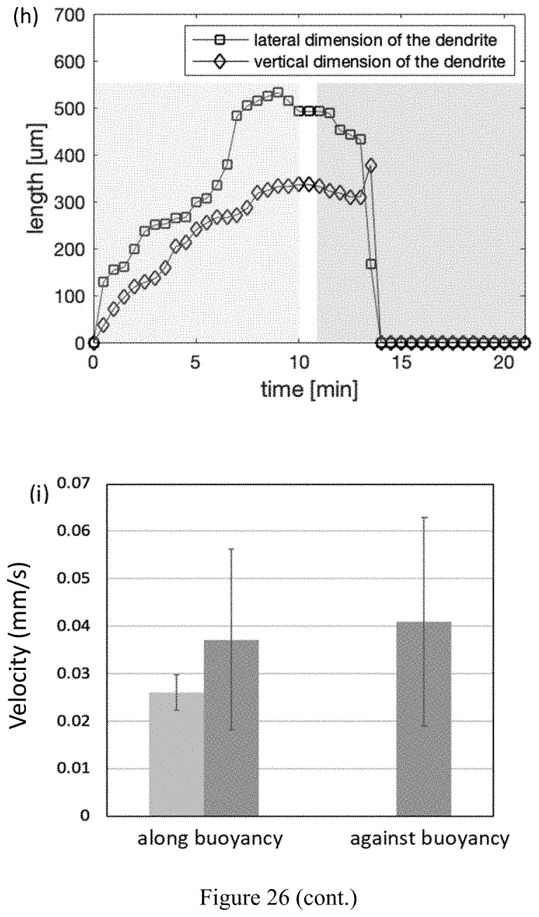

FIGS. 26(a)-(g) is a representation of the data collected from this visualization experiment setup. FIG. 26(g) is the corresponding voltage profile for where each of FIGS. 26(a)-(f) occurs in the electrochemical process, and FIGS. 26(a)-(f) are the observation of the anode side during a discharge cycle, in which Na was stripping away. FIG. 26(a) was taken at t=0 of this discharge cycle, which shows the dendritic deposition from the previous charging cycle. As the discharging started, the Na dendrites shrunk in size, which is demonstrated in FIG. 26(b). In an analogue study of lithium metal deposit, this low-potential stage is stripping from the dendrites, which has a lower potential barrier. The shrunk in size later stopped, as shown in FIG. 26(c), followed by a sharp increase in the potential. The potential then flatted out (region (d)), yet was never reach the level as low as region (b), which the higher energy input suggests that the Na dendrites can no longer supply enough active Na. Later in the stripping, it was observed that an entire dendrite was lifted up, indicating that there was pitting from the bulk Na, which weakened the connections between Na dendrites and bulk. When the discharge cycle finished, surprisingly the surface of the Na anode was entirely cleaned, as shown in FIG. 26(e). This phenomenon was repeatedly observed in the following discharging cycles as well, as shown in FIG. 26(f). This observation reveals to us how soft and fragile Na dendritic deposits are, and how severe the physical loss of Na deposits during cycles.

However, the leaving mechanism of Na dendrites remained not understood. Because Na dendrites have less density than the carbonate electrolyte used in this experiment, orphaned Na dendrite naturally floated up in the electrolyte. The setup in FIGS. 26(a)-(g) aligned the gravitational field (g-field) with electric field (e-field), so the breaking-off could be entire caused by buoyancy. To further investigate the effect if e-field also played a role on the detachment of Na dendrite from the anode, the orientation of the visualization cell was altered, making the e-field and g-field to be perpendicular to each other, and the experiment was run again holding all other parameters the same. FIG. 26(h) is a quantitative analysis of the growth of a single Na dendrite studied in this setup. This time, no immigration of orphaned Na dendrites from anode to cathode was observed, the dendrites left the frame right after they broke from the substrate. However, a stretch in the direction of e-field (the increase in vertical dimension around 13 min on FIG. 26(h)), which was very similar to the event happened in FIG. 26(d), still occurred. It was hypothesized that the stretch in the direction of e-field is an essential pre-leaving stage, but after detaching from the surface, buoyancy dominates the motion of the orphaned Na dendrites. An analysis on the velocity of the orphan pieces showed the velocity changes with strength of e-field and the direction of g-field, which further supports this hypothesis (FIG. 26(i)).

These results suggest that difference in density does not trigger the detachment of a Na dendrite, but the possible accumulation of charges in the Na dendrite is the key of the tearing after the connection between dendrites and bulk gets weaker. However, after the detaching, the orphaned Na carries very few net charges, the connection to the electrode is completely lost, all the previously accumulated charges are quickly neutralized by the environment (mainly the electrolyte), and the orphaned Na dendrites move around follows the buoyancy and the flow of electrolyte.

Visualization cell results suggest a low reversibility of a Na metal cell. To qualify this result and to test if such dramatic surface-cleaning event happens in a coin cell setup, a Coulombic efficiency (CE) test was performed on a Na-stainless steel (SS) coin cell using a Teflon washer (O-ring) as the spacer to completely eliminate the effect of mechanical pressure. The averaged CE for this coin cell is only about 2.98%. Although such low CE value was not reported by others, yet it matches with visualization observations well, confirming the surface-cleaning pheromone that was previously seen in a visualization cell.

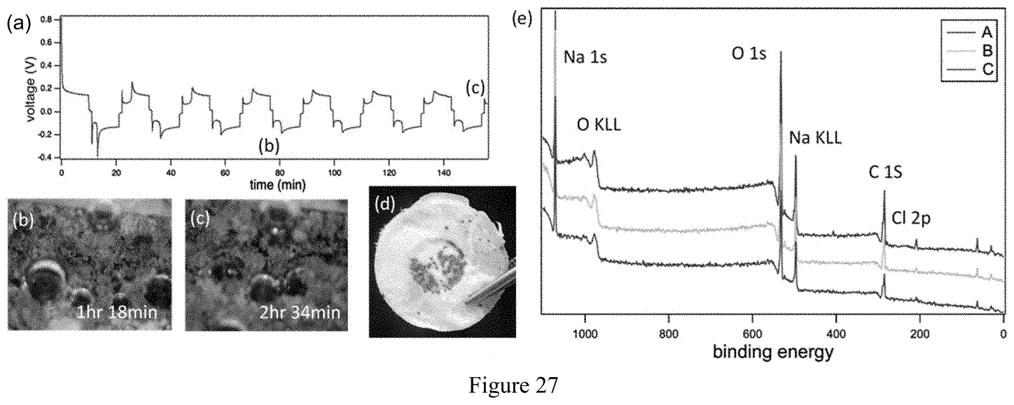

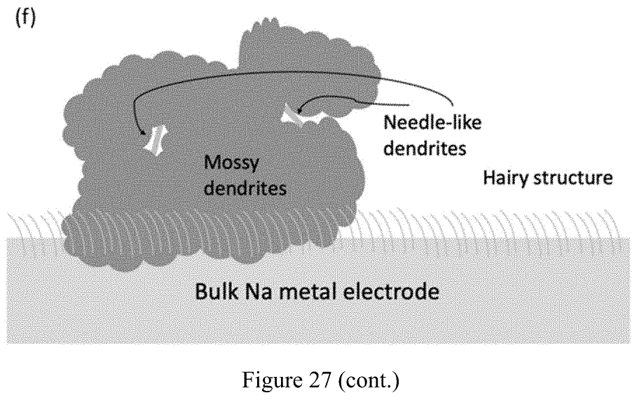

It is then not difficult to imagine how much orphaning Na deposits can be generated after a good amount of cycling time. FIGS. 27(a)-(c) reveal the astonishing amount of orphaning Na was generated in 2 hours of cycling show, at rate of 4 mA/cm². The corresponding voltage profile (FIG. 27(a)) shows that the presence of orphan Na does not affect the battery performance much when there was still room for electrolyte to pass through and the metal electrode can still supply enough Na ions. These observations suggest orphan Na dendrites are soft and not conductive, so that touching with each other does not necessarily generate short-circuit. To confirm this visualization result can be applied to coin cell systems as well, a symmetric Na-Na coin cell was run using glass fiber as the separator. The initial cycles had the same characteristic profile as the visualization cell, which supports that the visualization cell is a successful analogue to a coin cell, so the findings in the visualization cell are also meaningful to the closed coin cell system. Therefore, the observations in FIGS. 27(b) and (c) were used to explain the increase of the voltage in later cycles in a coin cell. The slow increase over long period of cycling may be caused by the increase in etching depth over time, and the final sharp shoot-up in voltage indicates that all the available Na was consumed up, where the cell has failed.

The activity of the mossy Na dendrites remained to be interesting. An X-ray photoelectron spectroscopy (XPS) analysis was done to study the composition of the mossy Na dendrite with comparison to that of the pristine Na metal. The soft and porous nature of glass fiber helps to catch and preserve the orphaned mossy Na dendrites (as shown in FIG. 27(d)), which was used as the separator in a coin-cell setup to obtain isolated mossy dendrites. The Na deposited on Na substrate is a sample for catching possible chemical difference among different morphologies of Na deposits, since the hairy deposits were only found at the bulk surface. The pristine Na metal piece was soaked in the same electrolyte to account for the effects on surface composition by the electrolyte. There was no binding energy shifts of either Na 1 s peak or Na KLL peak found among these three samples, which suggests that the Na atoms in dendrites have the same orbital configurations as those in the bulk metal. Furthermore, the ratios of the area-under-peak between Na KLL and O 1 s for all three samples are similar, which suggests a similar degree of oxidization of the Na. It further proves that the chemistry of the Na dendrites should be the same.

Architecture and Full Cell Cycling Performance: The choice of separator and the design of anode was investigated to determine if they can improve the reversibility of Na metal during cycling by providing better connection to the electrodes and fixing the dendrites to the surface to avoid loss of Na.

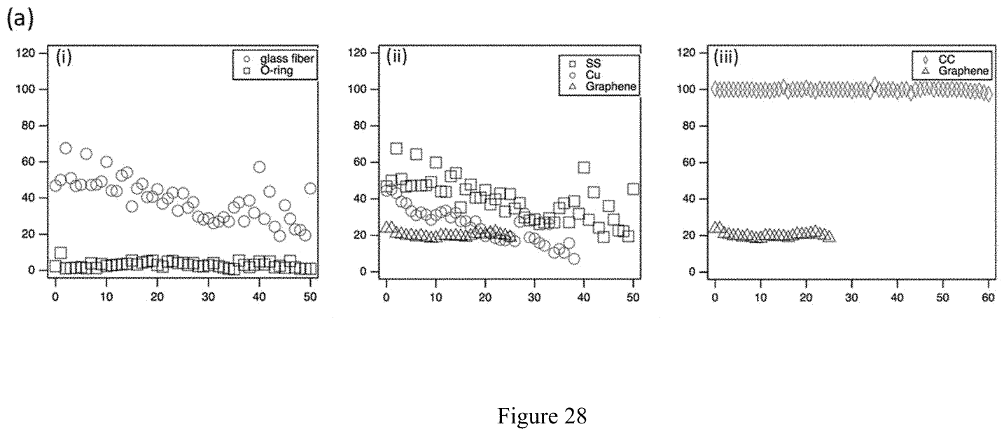

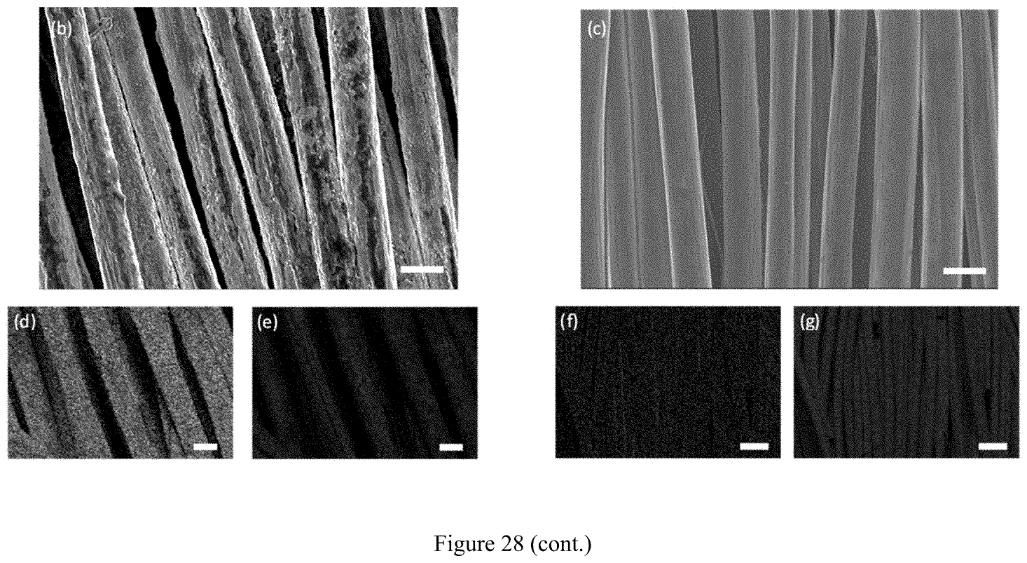

The CE of a Na∥Stainless Steel cell using a Teflon washer (O-ring) to hold electrolyte was only about 2.98%. However, while keeping the same O-ring setup, but switching from the planar SS electrode to carbon cloth (CC), which is a 3-D frame with good elasticity, it was found that the CE was improved from 2.98% to 54.6%. The performance of this 3-D electrode was tested in a more conventional coin cell setup, in which the O-ring was replaced by glass fiber. By switching to a separator that provided some extra constraints to dendritic growth, the CE for cell employing an SS counter electrode was improved from 2.98% to 38.6%, as shown in FIG. 28(a). No significant difference in the reversibility of Na was observed between planar SS and Cu, while a typical CE around 30% matches with the values that were previously reported. However, as presented in FIG. 28(a), using CC increased the CE from around 30% to averaged 99.9% for the first 60 cycles.

An X-ray powder diffraction (XRD) test was done to further study the reversibility of the Na deposits on CC. The two peaks associating with plating were matched with the (0 0 4) and (1 1 1) peaks of orthorhombic NaOH from the literature reference. Na is highly sensitive to air. Although the XRD sample preparation was done in an argon glovebox, complete inhibition of oxidation of Na metal was not achieved. The oxidation of Na under air had not yet process to Na₂CO₃ by the time the XRD was performed, yet essentially the majority of Na had been oxidized to NaOH, which is understandable as the theoretical thickness of Na coated on the surface of carbon fibers is less than 0.1 μm. The disappearing of the (0 0 4) and (1 1 1) peaks of orthorhombic NaOH for the stripped sample confirms the high reversibility of Na deposits on CC.

A scanning electron microscope (SEM) imaging with energy-dispersive X-ray (EDX) mapping investigation was done with the goal to visually support and explain the surprising improvement of employing a 3-D electrode. As shown in FIGS. 28(b)(d)(e), a smooth, even, and dense deposit of Na was observed on each carbon fiber. This suggests a low local current density caused by large available depositing area. Due to the good wetting of CC with ECPC, this “Na coating” was almost even through space. FIGS. 28(c)(f)(g) shows the high reversibility of this thin layer of Na coating. It was further found that excess Na tends to deposit inside rather than on at the surface of the CC because of the stronger e-field inside of the 3-D network. Therefore, in additional to providing a large surface area for Na to deposit, CC also provide extra electrochemical as well as mechanical constrains to hold Na deposits in place, which improves the cell performances in long term.

Another unique feature of CC is that Na ion intercalation happens with the metallic deposition. For the CE values reported in FIG. 28(a) and throughout this example, the capacity due to Na ion has been removed. It has also been found that the initial ion insertion with solvent PC changed the crystal structure of CC, enlarging the inter-plane spacing of graphene plates in the crystalline region of CC, which aids the later Na ion storage as well as Na metal deposition. Although traditionally graphite is believed to have a poor capacity of holding Na ions, which a greater lattice spacing of CC and the rupturing effect of PC, the CC used in this system shows a stable capacity of 0.35 mAh/cm² (43.8 mAh/g) to Na ions at 0.5 mA/cm². On top of this Na ion capacity, the metal deposition region also exhibits a high reversibility exceeding 99% at 1 mAh/cm² at 0.5 mA/cm² and a high reversibility exceed 90% at 3mAh/cm² at 1 mA/cm².

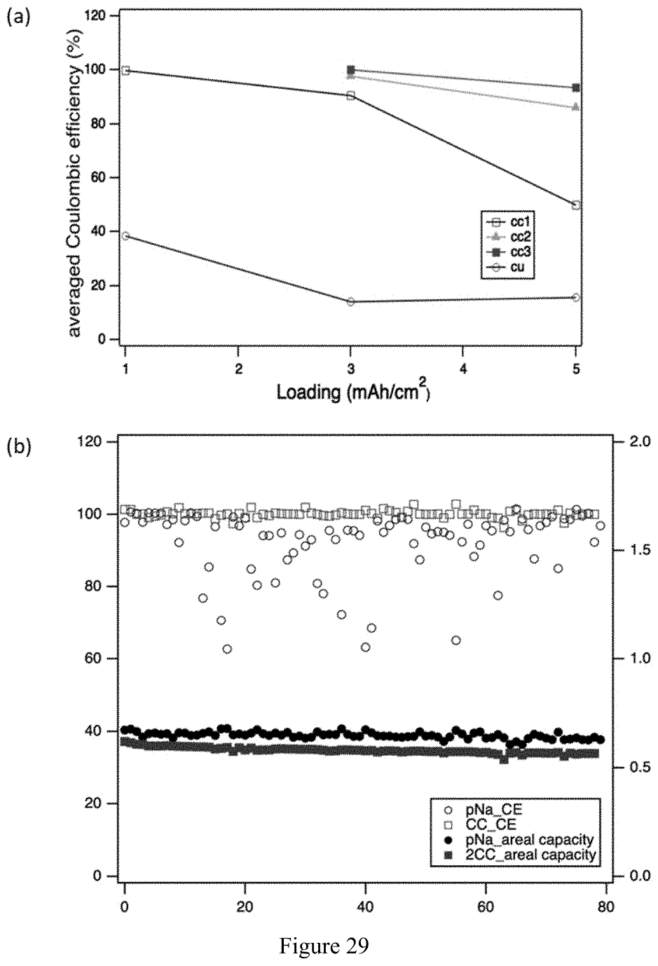

To further prove the benefits of employing a 3-D framework for Na deposition, a Na/CC hybrid 3-D anode was created by first electrochemically depositing Na to CC in a Na∥CC cell, and then it was paired with a carbon-sulfur composite cathode. In FIG. 29(a), the amount of Na deposited on CC and Cu was 3 mAh/cm², which is equivalent to a N/P ratio of 6; and the equivalent amount of Na available in the Na metal plate is about 40 mAh/cm², which is equivalent to a N/P ratio of 80. Comparing with pristine Na metal plate, Na/CC hybrid anode provides similar capacity yet helps the cell to achieve better CE.

While the cell with Na/Cu anode completely lost its capacity within the first 20 cycles, Na metal plate anode with greater N/P ratio survived until 350 cycles. However, the cell with Na/CC anode kept 80% of its capacity at the 450^{th} cycle, comparing with its capacity at the 2^{nd} cycle. FIG. 29(b) shows that individual charging and discharging curves for each cycle of the Na/CC anode cell was the same as the curves a regular Na metal anode cell.

The extremely soft and fragile nature of Na dendrites has been described. These observations provided a new thought on designing a hybrid Na metal anode. Unlike Li metal batteries, where the hard dendrite can break the separator and cause short-circuits, most Na metal batteries fail due to the physical loss of anode materials. The problem of orphaning Na during battery cycling can be largely reduced by using a 3-D framework anode as described herein.

Experimental methods: Materials: Electrolyte used in this study was NaClO₄ in EC/PC solution (50:50 by volume), prepared in our laboratory. All materials were kept under argon gas, and the electrolyte was extra dried with molecular sieve for overnight before using. Na metal used was purchased from Sigma Aldrich (cubes, under mineral oil, 99.9% trace metals basis).

Visualization: Visualization cells are quartz 3.5 mL cuvette purchased from Science Outlet (schematic shown in FIG. 25). Optical microscope used in this study was OLYMPUS DP 80 and Dino-Lite, and the battery tester used was Neware CT-3008W coin cell testing system. Electrolyte and Na plates used were as described in Materials.

Coin cell electrochemical tests: Two types of coin cells were assembled in this study. One used O-ring washer as the separator, with thickness about 0.8 mm and a hole in the center with diameter of ⅜″. The other type used glass fiber GF/B, purchased from Sigma Aldrich. Glass fiber plates were kept in 100° C. oven overnight for water removal. Electrolyte and Na plates used were as described in Materials. Plain carbon cloth 1071 HCB (from Fuel Cell Store) was used as purchased for making the CC counter electrode and CC/Na anodes. All tests were performed on Neware CT-3008W coin cell testing system.

Characterization: SEM and EDX images were taken on Zeiss GEMINI 500 Scanning Electron Microscope. XPS data was collected by technician at Cornell Center for Materials Research Shared Facilities.

Although the present disclosure has been described with respect to one or more particular embodiments and/or examples, it will be understood that other embodiments and/or examples of the present disclosure may be made without departing from the scope of the present disclosure.

1. An electrode or electrode material or catalyst or catalyst material comprising:
an electrically conducting 3-dimensional (3-D) matrix comprising a plurality of porous regions;
an active material, and
optionally, a carbon conductivity aid,
wherein the active material is disposed in and/or on at least a portion of the porous regions of the electrically conducting 3-D matrix.

2. The electrode or electrode material or catalyst or catalyst material of claim 1, wherein the porous regions are at least partially, substantially, or completely continuous and/or the porous regions have one or more dimension(s) or all dimensions of 100 nm to 200 microns.

3. The electrode or electrode material or catalyst or catalyst material of claim 1, wherein the electrically conducting 3-D matrix is carbon matrix.

4. The electrode or electrode material or catalyst or catalyst material of claim 3, wherein the carbon matrix is a carbon cloth/fabric.

5. The electrode or electrode material or catalyst or catalyst material of claim 4, wherein the cloth/fabric is woven or non-woven.

6. The electrode or electrode material or catalyst or catalyst material of claim 1, wherein the electrically conducting 3-D matrix is chosen from carbon frameworks, metal frameworks, and other frameworks formed from other conductive materials, and combinations thereof

7. The electrode or electrode material or catalyst or catalyst material of claim 1, wherein the active material is disposed on a surface of the electrically conducting 3-D matrix and/or in the porous regions.

8. The electrode or electrode material or catalyst or catalyst material of claim 1, wherein the electrode is a cathode and the active material is an ion-conducting material.

9. The electrode or electrode material or catalyst or catalyst material of claim 1, wherein the active material is a catalyst material chosen metals and metal oxides.

10. The electrode or electrode material or catalyst or catalyst material of claim 1, wherein the active material is a catalyst material and the ratio of catalyst material to carbon conductivity aid is 5:95 to 95:5.

11. The electrode or electrode material or catalyst or catalyst material of claim 1, wherein the carbon conductivity aid is a combination of an anisotropic carbon conductivity aid and an isotropic carbon conductivity aid.

12. The electrode or electrode material or catalyst or catalyst material of claim 1, wherein at least a portion of a surface of the electrically conducting 3-D matrix is surface modified.

13. A method of making an electrode or an electrode material or catalyst or catalyst material of claim 1 comprising:
contacting an active material powder and an electrically conducting 3-D matrix;
contacting the electrically conducting 3-D matrix and the active material powder disposed thereon and a layer of a material;
optionally, contacting the electrically conducting 3-D matrix, the active material powder, and the layer of the material with a liquid; and
optionally, applying a force to the electrically conducting 3-D matrix, the active material powder, the layer of the material, and the liquid,
wherein at least a portion of the active material is infiltrated into the electrically conducting 3-D matrix and the electrode or electrode material is formed.

14. The method of claim 13, wherein the layer of the material is an electrically conducting 3-D matrix.

15. The method of claim 13, wherein, prior to contacting the electrically conducting 3-D matrix, the active material powder, and the layer of the material with a liquid, at least a portion of an exterior surface of the second electrically conducting 3-D matrix is contacted with a second active material powder and a second layer of a material is contacted with a second electrically conducting 3-D matrix and a second active material powder, and, optionally, repeating the contacting steps a desired number of times to form a multilayer structure.

16. The method of claim 13, wherein the layer of the material is an electrically conducting 3-D matrix layer or a sacrificial layer.

17. The method of claim 13, wherein the liquid is an electrolyte.

18. The method of claim 13, wherein force is applied by a member.

19. A device comprising one or more electrode or electrode material or catalyst or catalyst material of claim 1.

20. The device of claim 19, wherein the device is an electrochemical device chosen from batteries, supercapacitors, fuel cells, electrolyzers, electrolytic cells, and combinations thereof.
